(19) United States
(12) Patent Application Publication
(10) Pub. No.: US 2016/0239907 A1
(43) Pub. Date: Aug. 18, 2016

(54) REVERSE AUCTION SYSTEM WITH GUARANTEED FUNDS AND DYNAMIC SALE ALLOCATION

(71) Applicant: BIDORA INC., Manhattan Beach, CA (US)

(72) Inventor: Michael Dolen, Manhattan Beach, CA (US)

(21) Appl. No.: 14/625,521

(22) Filed: Feb. 18, 2015

(51) Int. Cl. G06Q 30/08; G06Q 20/40; G06Q 30/06

(52) U.S. Cl. CPC G06Q 30/08; G06Q 30/0611; G06Q 20/403

(57) ABSTRACT

Described herein are computer-implemented reverse auction systems, having a reverse auction environment wherein sellers compete to obtain business from a buyer, featuring improvements comprising an assured demand allocation system with guaranteed buyer funds and automated dynamic item and price allocation.

### BACKGROUND OF THE INVENTION

A reverse auction is a type of auction in which the roles of buyer and seller are reversed. In an ordinary auction (also known as a forward auction), buyers compete to purchase one or more goods, services, rights, or a combination thereof by offering increasingly higher prices. However, in a reverse auction, a buyer offers to purchase one or more goods, services, rights, or a combination thereof, and a plurality of sellers compete to sell the one or more goods, services, rights, or a combination thereof by placing one or more bids.

### SUMMARY OF THE INVENTION

The inventor of the subject matter described herein provides a novel technical solution to problems associated with purchasing goods, services and/or rights through an intermediary application. In some embodiments, one or more prospective buyers contact one or more sellers to offer a lower price than the listing price of one or more goods, services, and/or rights. However, sellers are often hesitant to entertain such offers because it is difficult to gauge the seriousness of the buyer (e.g. whether the buyer is merely window shopping). Further, negotiating with individual buyers is time consuming, especially when doing so might not guarantee the sale will be completed. In some embodiments, when purchasing one or more goods, services, and/or rights, a consumer shops around to find the lowest price by negotiating with a plurality of sellers, however, in certain instances, a seller has no way of knowing whether the consumer is telling the truth. For example, a consumer seeking to purchase a new television goes through the time consuming process of individually contacting dozens or even hundreds of sellers and negotiating with each for a better price. However, when the consumer approaches a first seller and asks the seller if they will beat a second seller's price, the first seller does not know whether the consumer is telling the truth about the other offer.

The inventor of the subject matter described herein provides a novel technical solution to problems associated with purchasing goods, services and/or rights through an intermediary application. In some embodiments, manufacturers prohibit retailers from advertising a price below the manufacturer's suggested retail price (MSRP), even though the retailers are permitted to sell below MSRP. In some instances, sellers of a product would like to sell below MSRP but are prevented from telling the buyer as such. In various embodiments, manufacturers don't allow sellers to advertise prices below MSRP because manufacturers don't want a price war between retailers. However, this ultimately hurts consumers by stifling the free marketplace. For example, whether a consumer buys their Sony TV or Apple computer at Best Buy or Amazon, both retailers are required to advertise the same exact pricing.

The inventor of the subject matter described herein provides a novel technical solution to problems associated with purchasing goods, services and/or rights through an intermediary application. In some embodiments, consumers lack the confidence and/or skills needed to negotiate a better price. As a result, in some instances, consumers end up paying more than they would have had they properly negotiated for a lower price. In some embodiments, consumers who try to negotiate are discriminated against and/or taken advantage of due to factors such as age, gender, race, educational level, and language skills.

The inventor of the subject matter described herein provides a novel technical solution to problems associated with purchasing goods, services and/or rights through an intermediary application. In some embodiments, a pricing strategy of one or more sellers follows a bell curve (e.g. a normal and/or Gaussian distribution). In some instances, a seller of one or more goods, services, and/or rights would like every sale to be for an advertised price; however the seller is willing to provide a discount on a selective/limited basis (e.g. selling 80% of inventory at the advertised price, while selling 20% of inventory below that price). In some instances, this is difficult to accomplish because the primary method for doing so are sales events in which prices are discounted, and such sales events are often contingent on a time period in which the sale event occurs. For example, a retailer who offers $100 off a television purchase made during Labor Day weekend will sell the television to each buyer during Labor Day weekend, but after Labor Day weekend is over, no buyer gets the discount. However, the retailer would more than likely be willing to give that $100 discount on Tues., Wed., and Thurs. as long as the retailer selectively provides the discount (i.e. not every buyer receives the discount). Unfortunately, it is not practical to advertise that only some consumers will receive a discount (e.g. the seller is unlikely to advertise they will give a discount to every 5^{th} customer who walks in the door or every 5^{th} visitor who visits the website on Tues, Wed, and Thurs). Moreover, advertising as such detracts participation during the Labor Day weekend sale, thus taking away the “urgency” of having to make the purchase that weekend.

The inventor of the subject matter described herein provides a novel technical solution to problems associated with purchasing goods, services and/or rights through an intermediary application. In some embodiments, the intermediary application comprises a reverse auction and assured demand allocation system in which the seriousness of the buyer is backed by “guaranteed money” for the seller. Thus, sellers know the buyer isn't window shopping and the sale is guaranteed if the seller succeeds in winning the reverse auction. In some embodiments, the intermediary application facilitates and manages all offers made during the reverse auction. In such instances, managing all offers made during the reverse auction affords transparency and trust for all parties involved; each seller knows where their offer stands in relation to other competing offers.

The inventor of the subject matter described herein provides a novel technical solution to problems associated with purchasing goods, services and/or rights through an intermediary application. In some embodiments, the intermediary application comprises a reverse auction and an assured demand allocation system in which retailers are able to sell a product to an individual buyer below its MSRP, without needing to publicize this discount to the public at large. In some embodiments, the intermediary application comprising a reverse auction and an assured demand allocation system allows negotiation to occur via the intermediary application. By having negotiations occur over the intermediary application, sellers are “blind” to factors that place buyers at a disadvantage, for example, sellers don't know they are negotiating with a 90 year old lady, a high school dropout, or an Ivy League lawyer. Sellers only know a verified buyer is willing to purchase one or more goods, services, and/or rights and the buyer has committed the money to make the purchase. This creates a democratic process for negotiation, where everyone has an equal chance at getting the best deal.

The inventor of the subject matter described herein provides a novel technical solution to problems associated with purchasing goods, services and/or rights through an intermediary application. In some embodiments, the intermediary application comprises a reverse auction and an assured demand allocation system that allows sellers to seamlessly accomplish the bell curve by offering discounts to only a small selection of customers at any time. In some instances, this is because the reverse auction removes the variable of time dependency. In some instances, the buyer does not know a seller's identity but only knows that a trusted seller is willing to sell one or more goods, services, and/or rights in which the buyer is interested in purchasing. In some embodiments, this anonymity helps protect the seller from irritating other buyers who did not receive the same deal. In various embodiments, the identity of the winning seller is disclosed to the buyer. In some embodiments, buyers only know the qualitative scoring of sellers prior to a sale (e.g. a seller with a 5 star rating, a seller with a 98% satisfactory rating) so as to ensure they are purchasing from a legitimate and qualified seller.

In one aspect, in a computer-implemented reverse auction system having a reverse auction environment wherein sellers compete to obtain business from a buyer, disclosed herein are improvements comprising an assured demand allocation system with guaranteed buyer funds and automated dynamic item and price allocation comprising: a database, in a computer memory, of a plurality of qualified sellers; a software module configured to: receive an offer to buy from a buyer, the offer to buy directed to a plurality of items, each item having a price, the offer to buy having a total price; receive a proposed purchase price for the plurality of items from the buyer, the proposed purchase price being equal to or less than the total price; and calculate a respective share of the proposed purchase price for each item; a software module configured to verify availability of funds from the buyer in the amount of the proposed purchase price; a software module configured to receive bids from the qualified sellers, the bids for sale of one or more of the plurality of items, each bid having a price for each item in the bid; a software module configured to select one or more bidding sellers upon the expiration of a time period, each selected seller bidding on one or more of the plurality of items at a price equal to or less than the share of the proposed purchase price for the items in the bid; a dynamic item and price allocation module configured to apply an algorithm to allocate sale of each of the plurality of items to one or more of the selected sellers, wherein each item in the plurality of items is allocated at an allocated price, wherein the aggregate allocated price for the plurality of items is equal to or less than the proposed purchase price, the one or more sellers receiving the allocation based on one or more seller characteristics selected from the group consisting of: price, shipping speed, shipping provider, local delivery availability, local pickup availability, seller rating, seller ranking, number of previous sales, warranty, payment methods accepted, and condition of previously delivered items, the allocation immediately making the sale binding; and a software module configured to distribute the verified funds to the one or more sellers. In some embodiments, the items comprise goods, services, rights, or a combination thereof. In some embodiments, the price for each item in the offer to buy is a manufacturer's suggested retail price. In other embodiments, the price for each item in the offer to buy is a going rate for purchase. In further embodiments, the price for each item in the offer to buy is a going rate for online purchase. In other embodiments, the price for each item in the offer to buy is a list price. In some other embodiments, the price for each item in the offer to buy is derived from one or more of a manufacturer's suggested retail price, a going rate for purchase, a going rate for online purchase, and a list price. In some embodiments, the proposed purchase price comprises a partial payment for one or more of the plurality of items. In some embodiments, the offer to buy comprises the time period, the time period configured by the buyer. In other embodiments, the offer to buy comprises the time period, the time period configured by a software module based on the items. In some embodiments, the funds comprise cryptocurrency. In further embodiments, the cryptocurrency comprises Bitcoin, Namecoin, Litecoin, Peercoin, Ripple, Mastercoin, Primecoin, Dogecoin, Darkcoin, Auroracoin, or a combination thereof. In some embodiments, the funds comprise a coupon, a voucher, a gift card, currency, or a combination thereof. In some embodiments, the verifying the availability of funds comprises receiving the funds. In some embodiments, the verifying the availability of funds comprises receiving at least a portion of the funds.

In another aspect, disclosed herein are non-transitory computer-readable storage media encoded with a computer program including instructions executable by a processor to create an intermediary application for a reverse auction environment comprising: a database, in a computer memory, of a plurality of qualified sellers; a software module configured to: receive an offer to buy from a buyer, the offer to buy directed to a plurality of items, each item having a price, the offer to buy having a total price; receive a proposed purchase price for the plurality of items from the buyer, the proposed purchase price being equal to or less than the total price; and calculate a respective share of the proposed purchase price for each item; a software module configured to verify availability of funds from the buyer in the amount of the proposed purchase price; a software module configured to receive bids from the qualified sellers, the bids for sale of one or more of the plurality of items, each bid having a price for each item in the bid; a software module configured to select one or more bidding sellers upon the expiration of a time period, each selected seller bidding on one or more of the plurality of items at a price equal to or less than the share of the proposed purchase price for the items in the bid; a dynamic item and price allocation module configured to apply an algorithm to allocate sale of each of the plurality of items to one or more of the selected sellers, wherein each item in the plurality of items is allocated at an allocated price, wherein the aggregate allocated price for the plurality of items is equal to or less than the proposed purchase price, the one or more sellers receiving the allocation based on one or more seller characteristics selected from the group consisting of: price, shipping speed, shipping provider, local delivery availability, local pickup availability, seller rating, seller ranking, number of previous sales, warranty, payment methods accepted, and condition of previously delivered items, the allocation immediately making the sale binding; and a software module configured to distribute the verified funds to the one or more sellers. In some embodiments, the items comprise goods, services, rights, or a combination thereof. In some embodiments, the price for each item in the offer to buy is a manufacturer's suggested retail price. In other embodiments, the price for each item in the offer to buy is a going rate for purchase. In further embodiments, the price for each item in the offer to buy is a going rate for online purchase. In other embodiments, the price for each item in the offer to buy is a list price. In some embodiments, the price for each item in the offer to buy is derived from one or more of a manufacturer's suggested retail price, a going rate for purchase, going rate for online purchase, and a list price. In some embodiments, the proposed purchase price comprises a partial payment for one or more of the plurality of items. In some embodiments, the offer to buy comprises the time period, the time period configured by the buyer. In other embodiments, the offer to buy comprises the time period, the time period configured by a software module based on the items. In some embodiments, the funds comprise cryptocurrency. In further embodiments, the cryptocurrency comprises Bitcoin, Namecoin, Litecoin, Peercoin, Ripple, Mastercoin, Primecoin, Dogecoin, Darkcoin, Auroracoin, or a combination thereof. In some embodiments, the funds comprise a coupon, a voucher, a gift card, currency, or a combination thereof. In some embodiments, the verifying the availability of funds comprises receiving the funds. In some embodiments, the verifying the availability of funds comprises receiving at least a portion of the funds.

In another aspect, disclosed herein are systems for computer-implemented auction technology in which guaranteed funds are dynamically allocated among a plurality of acquired items, comprising: a digital processing device comprising an operating system configured to perform executable instructions and a memory; a computer program including instructions executable by the digital processing device to create an intermediary application for a reverse auction environment comprising: a database, in a computer memory, of a plurality of qualified sellers; a software module configured to: receive an offer to buy from a buyer, the offer to buy directed to a plurality of items, each item having a price, the offer to buy having a total price; receive a proposed purchase price for the plurality of items from the buyer, the proposed purchase price being equal to or less than the total price; and calculate a respective share of the proposed purchase price for each item; a software module configured to verify availability of funds from the buyer in the amount of the proposed purchase price; a software module configured to receive bids from the qualified sellers, the bids for sale of one or more of the plurality of items, each bid having a price for each item in the bid; a software module configured to select one or more bidding sellers upon the expiration of a time period, each selected seller bidding on one or more of the plurality of items at a price equal to or less than the share of the proposed purchase price for the items in the bid; a dynamic item and price allocation module configured to apply an algorithm to allocate sale of each of the plurality of items to one or more of the selected sellers, wherein each item in the plurality of items is allocated at an allocated price, wherein the aggregate allocated price for the plurality of items is equal to or less than the proposed purchase price, the one or more sellers receiving the allocation based on one or more seller characteristics selected from the group consisting of: price, shipping speed, shipping provider, local delivery availability, local pickup availability, seller rating, seller ranking, number of previous sales, warranty, payment methods accepted, and condition of previously delivered items, the allocation immediately making the sale binding; and a software module configured to distribute the verified funds to the one or more sellers. In some embodiments, the items comprise goods, services, rights, or a combination thereof. In some embodiments, the price for each item in the offer to buy is a manufacturer's suggested retail price. In other embodiments, the price for each item in the offer to buy is a going rate for purchase. In further embodiments, the price for each item in the offer to buy is a going rate for online purchase. In other embodiments, the price for each item in the offer to buy is a list price. In some embodiments, the price for each item in the offer to buy is derived from one or more of a manufacturer's suggested retail price, a going rate for purchase, a going rate for online purchase and a list price. In some embodiments, the proposed purchase price comprises a partial payment for one or more of the plurality of items. In some embodiments, the offer to buy comprises the time period, the time period configured by the buyer. In other embodiments, the offer to buy comprises the time period, the time period configured by a software module based on the items. In some embodiments, the funds comprise cryptocurrency. In further embodiments, the cryptocurrency comprises Bitcoin, Namecoin, Litecoin, Peercoin, Ripple, Mastercoin, Primecoin, Dogecoin, Darkcoin, Auroracoin, or a combination thereof. In some embodiments, the funds comprise a coupon, a voucher, a gift card, currency, or a combination thereof. In some embodiments, the verifying the availability of funds comprises receiving the funds. In some embodiments, the verifying the availability of funds comprises receiving at least a portion of the funds.

### INCORPORATION BY REFERENCE

All publications, patents, and patent applications mentioned in this specification are herein incorporated by reference to the same extent as if each individual publication, patent, or patent application was specifically and individually indicated to be incorporated by reference. Specifically, U.S. nonprovisional application Ser. No. ______, filed on ______, 2015 is hereby incorporated by reference.

### BRIEF DESCRIPTION OF THE DRAWINGS

FIG. 1 depicts a non-limiting example of the platforms, systems, media and methods described herein; in this case a reverse auction process.

FIG. 2 depicts a non-limiting example of the platforms, systems, media and methods described herein; in this case a price comparison alternate offer.

### DETAILED DESCRIPTION OF THE INVENTION

In a computer-implemented reverse auction system having a reverse auction environment wherein sellers compete to obtain business from a buyer, described herein, in certain embodiments, are improvements comprising an assured demand allocation system with guaranteed buyer funds and automated dynamic item and price allocation comprising: a database, in a computer memory, of a plurality of qualified sellers; a software module configured to: receive an offer to buy from a buyer, the offer to buy directed to a plurality of items, each item having a price, the offer to buy having a total price; receive a proposed purchase price for the plurality of items from the buyer, the proposed purchase price being equal to or less than the total price; and calculate a respective share of the proposed purchase price for each item; a software module configured to verify availability of funds from the buyer in the amount of the proposed purchase price; a software module configured to receive bids from the qualified sellers, the bids for sale of one or more of the plurality of items, each bid having a price for each item in the bid; a software module configured to select one or more bidding sellers upon the expiration of a time period, each selected seller bidding on one or more of the plurality of items at a price equal to or less than the share of the proposed purchase price for the items in the bid; a dynamic item and price allocation module configured to apply an algorithm to allocate sale of each of the plurality of items to one or more of the selected sellers, wherein each item in the plurality of items is allocated at an allocated price, wherein the aggregate allocated price for the plurality of items is equal to or less than the proposed purchase price, the one or more sellers receiving the allocation based on one or more seller characteristics selected from the group consisting of: price, shipping speed, shipping provider, local delivery availability, local pickup availability, seller rating, seller ranking, number of previous sales, warranty, payment methods accepted, and condition of previously delivered items, the allocation immediately making the sale binding; and a software module configured to distribute the verified funds to the one or more sellers.

Also described herein, in certain embodiments, are non-transitory computer-readable storage media encoded with a computer program including instructions executable by a processor to create an intermediary application for a reverse auction environment comprising: a database, in a computer memory, of a plurality of qualified sellers; a software module configured to: receive an offer to buy from a buyer, the offer to buy directed to a plurality of items, each item having a price, the offer to buy having a total price; receive a proposed purchase price for the plurality of items from the buyer, the proposed purchase price being equal to or less than the total price; and calculate a respective share of the proposed purchase price for each item; a software module configured to verify availability of funds from the buyer in the amount of the proposed purchase price; a software module configured to receive bids from the qualified sellers, the bids for sale of one or more of the plurality of items, each bid having a price for each item in the bid; a software module configured to select one or more bidding sellers upon the expiration of a time period, each selected seller bidding on one or more of the plurality of items at a price equal to or less than the share of the proposed purchase price for the items in the bid; a dynamic item and price allocation module configured to apply an algorithm to allocate sale of each of the plurality of items to one or more of the selected sellers, wherein each item in the plurality of items is allocated at an allocated price, wherein the aggregate allocated price for the plurality of items is equal to or less than the proposed purchase price, the one or more sellers receiving the allocation based on one or more seller characteristics selected from the group consisting of: price, shipping speed, shipping provider, local delivery availability, local pickup availability, seller rating, seller ranking, number of previous sales, warranty, payment methods accepted, and condition of previously delivered items, the allocation immediately making the sale binding; and a software module configured to distribute the verified funds to the one or more sellers.

Also described herein, in certain embodiments, are systems for computer-implemented auction technology in which guaranteed funds are dynamically allocated among a plurality of acquired items, comprising: a digital processing device comprising an operating system configured to perform executable instructions and a memory; a computer program including instructions executable by the digital processing device to create an intermediary application for a reverse auction environment comprising: a database, in a computer memory, of a plurality of qualified sellers; a software module configured to: receive an offer to buy from a buyer, the offer to buy directed to a plurality of items, each item having a price, the offer to buy having a total price; receive a proposed purchase price for the plurality of items from the buyer, the proposed purchase price being equal to or less than the total price; and calculate a respective share of the proposed purchase price for each item; a software module configured to verify availability of funds from the buyer in the amount of the proposed purchase price; a software module configured to receive bids from the qualified sellers, the bids for sale of one or more of the plurality of items, each bid having a price for each item in the bid; a software module configured to select one or more bidding sellers upon the expiration of a time period, each selected seller bidding on one or more of the plurality of items at a price equal to or less than the share of the proposed purchase price for the items in the bid; a dynamic item and price allocation module configured to apply an algorithm to allocate sale of each of the plurality of items to one or more of the selected sellers, wherein each item in the plurality of items is allocated at an allocated price, wherein the aggregate allocated price for the plurality of items is equal to or less than the proposed purchase price, the one or more sellers receiving the allocation based on one or more seller characteristics selected from the group consisting of: price, shipping speed, shipping provider, local delivery availability, local pickup availability, seller rating, seller ranking, number of previous sales, warranty, payment methods accepted, and condition of previously delivered items, the allocation immediately making the sale binding; and a software module configured to distribute the verified funds to the one or more sellers.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated. As used in this specification and the claims, unless otherwise stated, the term “about” refers to variations of +/−1%, +/−2%, +/−3%, +/−4%, +/−5%, +/−10%, +/−15%, or +/−25%, depending on the embodiment.

### Reverse Auction

In some embodiments, the platforms, systems, media, and methods described herein include a reverse auction environment, or use of the same. In some embodiments, in a reverse auction, the buyer submits an offer to purchase one or more goods, services, and/or rights. In various embodiments the offer may or may not have an associated price. In some embodiments, in a reverse auction, sellers bid for the prices at which they are willing to sell one or more goods, services, and/or rights. In various embodiments, the buyer indicates a time period for the reverse auction, for example, about one hour, about two hours, about three hours, about four hours, about five hours, about six hours, about seven hours, about eight hours, about nine hours, about ten hours, about eleven hours, about twelve hours, about thirteen hours, about fourteen hours, about fifteen hours, about sixteen hours, about seventeen hours, about eighteen hours, about nineteen hours, about twenty hours, about twenty-one hours, about twenty-two hours, about twenty-three hours, about one day, about two days, about three days, about four days, about five days, about six days, about one week, about two weeks, about three weeks, about one month, about two months, about three months, about four months, about five months, about six months, about seven months, about eight months, about nine months, about ten months, about eleven months, about one year, or greater than about one year. In various embodiments, the intermediary application comprises a software module configured to set the time period for the reverse auction based on the one or more items the buyer wants to purchase. In further or additional embodiments, the software module configured to set the time period for the reverse auction based on the one or more items the buyer wants to purchase, sets the time period based on availability of the one or more items.

In some embodiments, the platforms, systems, media, and methods described herein include a reverse auction environment, or use of the same. In various embodiments of a reverse auction, sellers place one or more bids for the amount they are willing to receive for the one or more goods, services, and/or rights. In various embodiments, one or more sellers place one or more bids in the reverse auction. In various embodiments, the seller with the lowest amount wins the auction. In various embodiments, the seller with the lowest bid when the time period for the reverse auction ends wins the reverse auction. In various embodiments, other characteristics of the seller and/or the one or more goods, services, and/or rights are taken into account to determine the winner of the reverse auction. In some embodiments, a reverse auction is in contrast to a regular auction where a seller offers to sell an item and one or more potential buyers place bids until the close of the auction, at which time the item goes to the highest bidder. In various embodiments, more than one seller wins the reverse auction, for example, when more than one item is included in the offer. In various embodiments, more than one seller wins the reverse auction and one or more goods, services, and/or rights the buyer offers to purchase is provided by each seller.

In some embodiments, the platforms, systems, media, and methods described herein include a reverse auction environment, or use of the same. In various embodiments, the reverse auction environment, effectuates bilateral buyer-driven commerce, for example, by affording prospective buyers to communicate a binding purchase offer to an intermediary application. In various embodiments, when buyers communicate the binding purchase to the intermediary application, relevant sellers are notified and the sellers are able to bid in the reverse auction environment. In various embodiments, relevant sellers are able to check with the host of the intermediary application to inquire whether a buyer has communicated a binding purchase to the intermediary application. In various embodiments the host provides a website and/or a web interface that sellers use to check whether a buyer has communicated a binding purchase to the intermediary application. In various embodiments, buyers pay a subscription fee to the host of the intermediary application in order to use the intermediary application to purchase goods, services, and/or rights. In various embodiments, sellers pay a subscription fee to the host of the intermediary application in order to use the intermediary application to sell goods, services, and/or rights. In various embodiments, buyers pay a commission to the host of the intermediary application in order to use the intermediary application to purchase goods, services, and/or rights. In various embodiments, sellers pay a commission to the host of the intermediary application in order to use the intermediary application to sell goods, services, and/or rights. In further or additional embodiments, when the buyer and/or seller pay a commission to the host of the intermediary application, the total price of one or more goods, services, and/or rights is the sum of the price of the one or more goods, services, and/or rights and the commission. In further or additional embodiments, the commission is a fixed fee, a percentage of the purchase price, or a combination thereof. In various embodiments, more than one seller wins the reverse auction, for example, when more than one item is included in the binding purchase offer. In various embodiments, more than one seller wins the reverse auction and one or more goods, services, and/or rights the buyer offers to purchase is provided by each seller.

In some embodiments, the platforms, systems, media, and methods described herein include a reverse auction environment, or use of the same. In various embodiments, when a qualified seller bids at or below the buyer's specified reserve price, the offer will become binding. In further or additional embodiments, if multiple bids from a plurality of sellers are at or below the buyer's specified reserve price, the sole winner will be determined based upon quantitative data (e.g. lowest price, which, in some embodiments, incorporates secondary quantitative data such as shipping and handling costs) and/or qualitative data (e.g. seller reputation, ranking, rating, review score(s), number of previous sales, payment methods accepted, condition of previously delivered items, location, speed of delivery, shipping provider, local delivery availability, local pickup availability, and auxiliaries such as warranties and/or guarantees). In various embodiments, more than one seller wins the reverse auction, for example, when more than one item is included in the binding purchase offer.

In some embodiments, the platforms, systems, media, and methods described herein include a reverse auction environment, or use of the same. In various embodiments, the buyer is an intermediary that will receive a commission when the intermediary sells to a customer one or more goods, services, and/or rights purchased form the seller. In further or additional embodiments, the intermediary will maximize his/her profit by selecting the seller who is willing to maximize the amount of money received by the intermediary while being able to sell one or more goods, services, and/or rights to the customer at a reasonable price and/or a price offered by the customer. In various embodiments, the price for one or more goods, services, and/or rights is the same or different for one or more sellers and the commission is the same or different for one or more sellers. As a non-limiting example, both Walmart and Best Buy propose to sell a good for $100, but Walmart is willing to pay 1% commission while Best Buy is willing to pay 4% commission. In this non-limiting example, the sale is awarded to Best Buy because they pay a higher commission. As another non-limiting example, Walmart sells the good for $100 with 1% commission while Best Buy sells same good for $102 with 4% commission. Although, Best Buy sells the good for a higher price, the intermediary application chooses Best Buy as the winner because the purchase maximizes the profit from the sale.

In some embodiments, the platforms, systems, media, and methods described herein include a reverse auction environment, or use of the same. In some embodiments, in a reverse auction, a plurality of buyers submit one or more offers to purchase one or more goods, services, and/or rights. In various embodiments, one or more of the buyers in the plurality of buyers offers to purchase one or more of the same goods, services, and/or rights. In various embodiments, one or more of the buyers in the plurality of buyers offers to purchase one or more different goods, services, and/or rights. In further or additional embodiments, the plurality of buyers collaborate to submit one or more offers to purchase one or more goods, services, and/or rights such that the one or more offers are grouped and the one or more goods, services or rights are offered to be purchased in one or more reverse auctions. The intermediary application, in some embodiments, groups the offers placed by the plurality of buyers such that a reverse auction is initiated for a plurality of goods, service, and/or rights indicated in the plurality of offers. In further or additional embodiments, the intermediary groups the offers from the plurality of buyers without knowledge of one or more of the plurality of buyers. This allows the intermediary application to effectively maximize the sale of one or more goods, services, and/or rights by leveraging the combination of offers. Maximizing the sale of one or more goods, services, and/or rights will, in some embodiments, maximize the profit for the one or more sellers and/or the intermediary application, for example, by collecting a commission and/or a fee from one or more sellers.

In some embodiments, the platforms, systems, media, and methods described herein include a reverse auction environment, or use of the same. In various embodiments, when a binding purchase between a buyer and one or more sellers is effectuated, the buyer's verified funds are automatically transferred to the one or more sellers such that the buyer and/or the seller cannot modify the purchase. In various embodiments, when a binding purchase between a buyer and one or more sellers is effectuated, the buyer and/or the seller is able to modify the purchase such that the purchase price is increased or decreased. In further or additional embodiments, when the purchase price is increased the buyer authorizes additional funds be transferred to the seller. In further or additional embodiments, when the purchase price is decreased the seller authorizes a refund of the amount of price decrease to the buyer. In various embodiments, when a binding purchase between a buyer and one or more sellers is effectuated, the buyer and/or the seller is able to modify the purchase such that one or more additional goods, services, and/or rights are purchased. In further or additional embodiments, when the buyer purchases one or more additional goods, services, and/or rights, the buyer authorizes funds to be transferred to the seller for the purchase price of the one or more additional goods, services, and/or rights. In various embodiments, when a binding purchase between a buyer and one or more sellers is effectuated, the buyer and/or the seller agree to mutually nullify the purchase such that the purchase is no longer binding. In further or additional embodiments, when the buyer and/or the seller agree to mutually nullify the purchase, the funds are not transferred from the buyer to the seller and/or the funds are refunded to the buyer. In further or additional embodiments, when the buyer and/or the seller agree to mutually nullify the purchase, the one or more goods, services, and/or rights are returned to the seller and/or the one or more goods and/or rights are not sent by the seller. In further or additional embodiments, when the buyer and/or the seller agree to mutually nullify the purchase, the one or more services are not provided by the seller. In various embodiments, nullifying and/or modifying a binding purchase is governed by local law, municipal law, city law, state law, U.S.A. law, laws of a foreign jurisdiction, international law, or a combination thereof. In further or additional embodiments, a law is an ordinance and/or a rule.

### Assured Demand Allocation

In some embodiments, the platforms, systems, media, and methods described herein include an assured demand allocation system, or use of the same. In various embodiments, the assured demand allocation system effectuates performance of the agreement between the buyer and seller, for example, by guaranteeing payment from the buyer to the seller for the purchase. In further or additional embodiments, assured demand allocation is accomplished by managing a payment system between the buyer and seller. In a first non-limiting example, assured demand allocation is managed using a method of payment comprising credit cards, debit cards, electronic funds transfer, electronic payment methods, a coupon, a voucher, a gift card, digital cash, currency, and currency alternatives such as a cryptocurrency. In various embodiments, electronic payment methods comprise PayPal, Google Wallet, 2Checkout, Shill, and Apple Pay. In various embodiments, cryptocurrency comprises Bitcoin, Namecoin, Litecoin, Peercoin, Ripple, Mastercoin, Primecoin, Dogecoin, Darkcoin, Auroracoin, or a combination thereof. In a second non-limiting example, assured demand allocation comprises an escrow account associated with the buyer, wherein funds advanced by the buyer to cover the purchase of a desired one or more goods, services, and/or rights are held by a third party pending fulfillment by a qualified seller. When a seller wins a binding purchase offer, the funds are debited from the escrow account and remitted to the seller automatically. In various embodiments, the escrow account is held by a third party and/or the host of the intermediary application configured to provide a reverse auction. In further or additional embodiments, the third party is a bank and/or an escrow company.

In some embodiments, the platforms, systems, media, and methods described herein include an assured demand allocation system, or use of the same. In various embodiments, when a seller does not ship the one or more goods the buyer purchased, at least a portion of the buyer's funds are refunded and/or not transferred to the seller. In various embodiments, when a seller does not provide the one or more services the buyer purchased, at least a portion of the buyer's funds are refunded and/or not transferred to the seller. In various embodiments, when a seller does not transfer the one or more rights the buyer purchased, at least a portion of the buyer's funds are refunded and/or not transferred to the seller.

In some embodiments, the platforms, systems, media, and methods described herein include an assured demand allocation system, or use of the same. In various embodiments, the assured demand allocation system effectuates performance of the agreement between the buyer and seller, for example, by guaranteeing payment from the buyer to the seller for the purchase. In further or additional embodiments, assured demand allocation is accomplished by managing a payment system between the buyer and seller. In some embodiments, a third party guarantees performance of the total price on behalf of the buyer. In some embodiments, a third party guarantees performance of the total price on behalf of the buyer only if the buyer does not pay the total price. In various embodiments, the third party is a person, a corporation, and/or the host of intermediary application configured to provide a reverse auction. In some embodiments, a third party guarantees performance of at least a portion of the price on behalf of the buyer. In some embodiments, a third party guarantees performance of at least a portion of the price on behalf of the buyer if the buyer does not pay the at least a portion of the price. In some embodiments, a third party guarantees performance of the total price on behalf of the buyer if the buyer does not pay at least a portion of the total price. In various embodiments, the third party is a person, a corporation, and/or the host of intermediary application configured to provide a reverse auction.

In some embodiments, the platforms, systems, media, and methods described herein include an assured demand allocation system, or use of the same. In various embodiments, the assured demand allocation system effectuates performance of the agreement between the buyer and seller, for example, by guaranteeing payment to the seller for the purchase. In some embodiments, the intermediary application guarantees payment to the seller on behalf of the buyer. In various embodiments, when the intermediary application guarantees payment to the seller on behalf of the buyer the intermediary application does not obtain proof of payment from the buyer before a reverse auction. In further or additional embodiments, when the intermediary application guarantees payment to the seller on behalf of the buyer, a buyer initiates a reverse auction for one or more goods, services, and/or rights, and a seller is successful in winning the reverse auction, the intermediary application pays the seller and later and/or instantly receives payment from the buyer. In further or additional embodiments, the host of the intermediary application purchases insurance such that if a buyer does not pay for the one or more goods, services, and/or rights, the host of the intermediary application will be able to file a claim and recoup at least a portion of the payment provided to the seller. In various embodiments, the intermediary application guarantees payment to the seller on behalf of the buyer when the buyer has earned credit with the intermediary application by, for example, previously offering to purchase one or more goods, services, and/or rights in a reverse auction and consistently having funds to pay for the one or more goods, services, and/or rights. In further or additional embodiments, a buyer earns credit with the intermediary application by consistently completing one or more reverse auctions. As a non-limiting example, a buyer earns credit when the buyer has previously successfully completed tens, hundreds, thousands, and/or millions of reverse auctions. In further or additional embodiments, a buyer earns credit with the intermediary application by consistently completing one or more reverse auctions amounting to a dollar value. As a third non-limiting example, a buyer earns credit when the buyer has previously successfully completed one or more reverse auctions amounting individually or in total to greater than $1, about $2, about $3, about $4, about $5, about $10, about $20, about $30, about $40, about $50, about $60, about $70, about $80, about $90, about $100, about $150, about $200, about $250, about $300, about $350, about $400, about $450, about $500, about $550, about $600, about $650, about $700, about $750, about $800, about $850, about $900, about $950, about $1,000, about $1500, about $2000, about $2500, about $3000, about $3500, about $4000, about $4500, about $5,000, about $6,000 about $7,000 about $8,000 about $9,000, about $10,000, about $20,000, about $30,000, about $40,000, about $50,000, about $60,000, about $70,000, about $80,000, about $90,000, about $100,000, or greater than about $100,000. In further or additional embodiments, a buyer earns credit when the buyer confirms their identity. In further or additional embodiments, a buyer earns credit when the buyer confirms he/she works for or is affiliated with a particular company, organization, government, government entity, and/or institution. As a non-limiting example, a buyer earns credit when the buyer confirms he works for or is a student at the University of Michigan by verifying their @umich.edu email address with the intermediary application.

In some embodiments, a third party guarantees performance of the total price on behalf of the buyer. In some embodiments, a third party guarantees performance of the total price on behalf of the buyer only if the buyer does not pay the total price. In various embodiments, the third party is a person, a corporation, and/or the host of intermediary application configured to provide a reverse auction. In some embodiments, a third party guarantees performance of at least a portion of the price on behalf of the buyer. In some embodiments, a third party guarantees performance of at least a portion of the price on behalf of the buyer if the buyer does not pay the at least a portion of the price. In some embodiments, a third party guarantees performance of the total price on behalf of the buyer if the buyer does not pay at least a portion of the total price. In various embodiments, the third party is a person, a corporation, and/or the host of intermediary application configured to provide a reverse auction.

In some embodiments, the platforms, systems, media, and methods described herein include an assured demand allocation system, or use of the same. In some embodiments, a buyer purchases one or more credits from an entity, and the credits are used to make a binding purchase offer using the intermediary application. In various embodiments, the credits are associated with a monetary value, for example about $1, about $2, about $3, about $4, about $5, about $10, about $20, about $50, about $100, about $500, about $1,000, about $5,000, about $10,000, about $50,000, about $100,000 or greater than about $100,000. In further or additional embodiments, currencies other than the dollar are used. In various embodiments, the entity is a third party, for example a private or public corporation and/or a bank. In various embodiments, the entity is the host of intermediary application configured to provide a reverse auction. In various embodiments, when one or more sellers win the reverse auction, the seller is paid by the entity from which credits were purchased thereby guaranteeing payment from the buyer to the seller by the entity. In various embodiments, when a seller wins the reverse auction, the seller is paid by the entity from which credits are purchased only if the buyer does not provide to the seller another form of payment. As a first non-limiting example, the buyer cancels his credit card, checking account, and/or savings account which was used to verify funds thereby preventing payment via that method and the entity pays the seller on behalf of the buyer. As a second non-limiting example, the buyer decides not to pay using his credit card, checking account, and/or savings account which was used to verify funds thereby preventing payment via that method and the entity pays the seller on behalf of the buyer. In some embodiments, credits are purchased by the buyer or on behalf of the buyer as a form of insurance. In various embodiments, the credits purchased as a form of insurance are used to pay the seller in the event the buyer does not pay and/or defaults on a payment.

### Items

In some embodiments, the platforms, systems, media, and methods described herein include a plurality of items, or use of the same. In various embodiments, the plurality of items comprises one or more goods, services and/or rights. In some embodiments, a good comprises a consumer product, a consumer good, and/or a final good. In some embodiments, examples of consumer products, consumer goods and/or firm goods comprise consumer electronics, music players, TVs, smart phones, clothing, children's toys, and handbags. In some embodiments, a good comprises a shopping product, for example a car, a house, and a laptop. In some embodiments, a good comprises a specialty product, for example a men's suit, women's designer handbags, expensive watches, and expensive wine. In some embodiments, a good is an unsought good, for example a fire extinguisher, an encyclopedia, and life insurance. In some embodiments a good comprises a business product, for example crude oil, wood, machinery, photocopiers, and paper. In some embodiments a good comprises an industrial product. In some embodiments, a good comprises a ticket for access to a place and/or event. In further or additional embodiments, the place and/or event is a concert, a sporting event, a state park, a national park, a state monument, a national monument, and/or any other place or event that requires a ticket for access. In some embodiments, a good comprises a ticket for transportation. In various embodiments, the ticket for transportation provides access to and use of a taxi, a bus, an UBER, a Lyft, an airplane, a boat, and/or any other transportation methods that require a ticket for access and use. In some embodiments, a good comprises a pet, livestock, or a plant.

In some embodiments, the platforms, systems, media, and methods described herein include a plurality of items, or use of the same. In various embodiments, the plurality of items comprises one or more goods, services and/or rights. In various embodiments, the service provided is at a restaurant, a cafe, and/or a bar. In various embodiments, the one or more goods comprise a meal, an appetizer, a desert, and a drink, wherein the meal, the appetizer, the desert, and/or the drink are purchased from one or more restaurants, cafes, and/or bars.

In some embodiments, the platforms, systems, media, and methods described herein include a plurality of items, or use of the same. In various embodiments, the plurality of items comprises one or more goods, services and/or rights. In various embodiments, the service provided is a professional service. In various embodiments, the service provided is a non-professional service. As a non-limiting example, unskilled labor is a non-professional service.

In some embodiments, the platforms, systems, media, and methods described herein include a plurality of items, or use of the same. In various embodiments, the plurality of items comprises one or more goods, services and/or rights. In some embodiments, the service comprises plumbing, electrical work (i.e. work conducted by an electrician or an equivalent thereof), heating and cooling, window washing, construction, remodeling, decorating, gardening, landscaping service, cleaning, legal services, financial advising services, chef/cooking services, shopping services, babysitting, daycare services, and any other services provided by an individual and/or a corporation. In some embodiments, a service comprises a service associated with the health and/or well-being of a person and/or animal. As a non-limiting example, the service provider comprises a realtor, an architect, a consultant, an attorney, a physician, a plastic surgeon, a dentist, a chiropractor, a medical professional, a therapist, a masseuse/masseur, a physical therapist, a life coach, a nutritionist, a trainer, a motivational speaker. Those of skill in the art will recognize that services and/or service providers not explicitly stated are incorporated herein.

In some embodiments, the platforms, systems, media, and methods described herein include a plurality of items, or use of the same. In various embodiments, the plurality of items comprises one or more goods, services and/or rights. In various embodiments, the service is provided by a small business. In various embodiments, the service is provided by an individual. Those of skill in the art will recognize that, in some embodiments, a service comprises any definable service.

In some embodiments, the platforms, systems, media, and methods described herein include a plurality of items, or use of the same. In various embodiments, the plurality of items comprises one or more goods, services and/or rights. In some embodiments, the service comprises a professional service. In some embodiments, the service comprises a professional healthcare service. In some embodiments, the service comprises a professional medical-related service.

In some embodiments, the platforms, systems, media, and methods described herein include a plurality of items, or use of the same. In various embodiments, the plurality of items comprises one or more goods, services and/or rights. In various embodiments, a right is a property right and/or any other legally binding right.

### Qualified Sellers

In some embodiments, the platforms, systems, media, and methods described herein include a database of qualified sellers, or use of the same. In various embodiments a seller requests to be a qualified seller, for example, by signing up for an account on the website of the host of the intermediary application configured to provide a reverse auction. In further or additional embodiments, when the seller requests to be entered as a qualified seller, the host requests proof that the seller is able to provide the one or more goods, services, and/or rights. In further or additional embodiments, proof is provided by the seller by showing previous sales records and/or settled invoices. In various embodiments, well-known and/or accredited sellers are not required to provide proof. In various embodiments, qualified sellers are persons and/or businesses authorized by a manufacturer to sell goods manufactured by the manufacturer. In various embodiments, qualified sellers are persons and/or businesses authorized by a manufacturer to install goods manufactured by the manufacturer. In various embodiments, qualified sellers are persons and/or businesses authorized to provide a service. In further or additional embodiments, an accredited seller is one who has a high rating with the Better Business Bureau or other business rating company/agency.

In some embodiments, the platforms, systems, media, and methods described herein include a database of qualified sellers, or use of the same. In various embodiments, a qualified seller is based on a seller reputation, ranking, rating, review score(s), number of previous sales, payment methods accepted, condition of previously delivered items, location, speed of delivery, local delivery availability, local pickup availability, and auxiliaries such as warranties and/or guarantees. In further or additional embodiments, the seller reputation is based on reviews and/or ratings from review websites such as Yelp and Angie's List. In further or additional embodiments, the seller reputation is based on reviews such as consumer reports, for example the corporation Consumer Reports. In various embodiments, a seller ranking is the same as a seller reputation. In various embodiments, a seller ranking is based on historical sales data compiled by the host of the intermediary application configured to provide a reverse auction. In various embodiments, a seller ranking is based on sales data compiled by one or more virtual marketplaces such as Amazon and/or eBay.

In some embodiments, the platforms, systems, media, and methods described herein include a database of qualified sellers, or use of the same. In various embodiments, a qualified seller is based on a seller reputation, ranking, rating, review score(s), number of previous sales, payment methods accepted, condition of previously delivered items, location, speed of delivery, local delivery availability, local pickup availability, and auxiliaries such as warranties and/or guarantees. Those of skill in the art will recognize that characteristics not disclosed herein are, in some embodiments, useful to determine if a seller is qualified. In further or additional embodiments, the seller rating, one or more review scores of a seller are based on reviews on the website of the host of the intermediary application configured to provide a reverse auction. In further or additional embodiments, the seller rating, one or more review scores of a seller are obtained from external review websites.

In some embodiments, the platforms, systems, media, and methods described herein include a database of qualified sellers, or use of the same. In various embodiments, a qualified seller is based on a seller reputation, ranking, rating, review score(s), number of previous sales, payment methods accepted, condition of previously delivered items, location, speed of delivery, local delivery availability, local pickup availability, and auxiliaries such as warranties and/or guarantees. In various embodiments, a qualified seller is in close proximity to the location in which the buyer is located, for example in the same neighborhood, zip code, village, town, city, county, state, and/or country. In various embodiments, a qualified seller is available for local delivery and/or local pickup when the seller is in close proximity to the location in which the buyer is located, for example in the same neighborhood, zip code, village, town, city, county, state, and/or country. In various embodiments, the location of the seller is not important as long as the seller is willing to ship the one or more goods and/or provide the one or more services. In various embodiments, the speed of delivery is used to determine a qualified seller. In further or additional embodiments, the speed of delivery from the seller is stated by the seller. In further or additional embodiments, the speed of delivery from the seller is based on reviews and/or ratings from review websites such as Yelp and Angie's List. In further or additional embodiments, the speed of delivery from the seller is based on reviews such as consumer reports, for example the corporation Consumer Reports. In various embodiments, the speed of delivery from the seller is based on data compiled by one or more web marketplaces such as Amazon and/or eBay. In various embodiments, the speed of providing the service is used to determine a qualified seller. In further or additional embodiments, the speed of providing the service is stated by the seller. In further or additional embodiments, the speed of providing the service is based on reviews and/or ratings from review websites such as Yelp and Angie's List. In various embodiments, the speed of providing the service is based on data compiled by one or more web marketplaces such as Amazon, eBay, and/or Craigslist. In various embodiments, auxiliaries such as warranties and/or guarantees are used to determine a qualified seller. In further or additional embodiments, auxiliaries are offered by the seller. In some embodiments, auxiliaries offered by the seller are incentives for a buyer to accept the seller's bid.

### Offer to Buy

In some embodiments, the platforms, systems, media, and methods described herein include an offer to buy from a buyer, or use of the same. In some embodiments, in a reverse auction, the buyer puts up an offer for one or more goods, services and/or rights, in which the offer has or does not have an associated price. In various embodiments, buyers communicate a binding purchase to the intermediary application configured to host a reverse auction. In various embodiments, a buyer communicates a reserve price such that the buyer effectuates a binding purchase agreement to pay at most the reserve price for one or more goods, services, and/or rights as long as long as one or more sellers bid at or below the reserve price and/or one or more sellers satisfy seller criteria (specified below). In further or additional embodiments, satisfying the seller criteria requires satisfying a subset of the seller criteria specified by the buyer. In various embodiments, a buyer communicates a reserve price and verifies only a portion of the reserve price; although the buyer has only verified a portion of the reserve price, the buyer effectuates a binding purchase agreement to pay at most the reserve price for one or more goods, services, and/or rights as long as one or more sellers bid at or below the reserve price and/or satisfy seller criteria (specified below). In further or additional embodiments, satisfying the seller criteria requires satisfying a subset of the seller criteria specified by the buyer. In various embodiments, a price for one or more goods, services, and/or rights is provided by the buyer. In various embodiments, a price for a one or more goods, services, and/or rights is a going rate for purchase, a going rate for online purchase, a MSRP, and/or a list price.

In some embodiments, the platforms, systems, media, and methods described herein include an offer to buy from a buyer, or use of the same. In some embodiments, a going rate is the price for one or more goods, services and/or rights using the prevailing market price as a basis. In further or additional embodiments, pricing based on a going rate is used when one or more goods, services, or rights has little variation from one seller of the one or more goods, services, and/or rights to another. In various embodiments a going rate for online purchase is the price for one or more goods, services and/or rights using the prevailing online market price as a basis. In further or additional embodiments, pricing based on a going rate for online purchase is used when one or more goods, services, or rights has little variation from one seller of one or more goods, services, and/or rights to another.

In some embodiments, the platforms, systems, media, and methods described herein include an offer to buy from a buyer, or use of the same. In some embodiments, the list price is the manufacturer's suggested retail price. In various embodiments, the list price is the service providers suggested service price. In various embodiments, the list price is the price the seller of the right sets as their asking price. In various embodiments, the list price is the initial asking price for one or more goods, services, and/or rights based on previous sales of the same and/or similar goods, services, and/or rights. In further or additional embodiments, previous sales of the same and/or similar goods, services, and/or rights are limited to a nearby geographic region. In further or additional embodiments, the nearby geographic region is the same neighborhood, zip code, village, town, city, county, state, and/or country. In various embodiments, the list price is a starting price and not necessarily the price that the seller will sell the one or more goods, services, and/or rights.

In some embodiments, the platforms, systems, media, and methods described herein include an offer to buy from a buyer, or use of the same. In various embodiments, the platforms, systems, media, and methods described herein provides guidance for one or more buyers in an auction environment, for example a reverse auction environment. In various embodiments the guidance is applicable in forward auctions as well as reverse auctions. In various embodiments, guidance is provided to a seller. In some embodiments, in a reverse auction, a buyer does not know an appropriate price at which to offer to purchase one or more goods, services and/or rights. In various embodiments, in a reverse auction, a buyer does not know the appropriate price to set as their reserve price. In further or additional embodiments, a buyer does not know an appropriate price at which to offer and/or an appropriate price to set a reserve price because the buyer does not know the profit margins on the one or more desired goods, services, and/or rights. For example, in a reverse auction where a buyer offers $500 for a name brand television which retails for $1,000, the buyer will likely not attract a seller since a seller's profit margin on consumer electronics is often less than 10%. As a result, the reverse auction would likely be a failure. However if the buyer has a realistic expectation of what would be a reasonable offer to get a “good deal,” then the reverse auction will be more likely to succeed. In some embodiments, to accomplish this, the auction system calculates guidance for the buyer based on factors comprising historical sales data for the desired one or more goods, services, and/or rights (e.g. previous auction history for the one or more goods, services, and/or rights), average profit margins for the one or more goods, services, and/or rights category (e.g. consumer electronics), and a length of time the one or more goods, services, and/or rights has been on the market. In various embodiments, one or more factors used to generate the guidance is presented in an interface comprising text, charts, scales, and other graphical interfaces. In various embodiments, historical sales data for the desired one or more goods, services, and/or rights is determined from other virtual marketplaces such as Amazon and/or eBay. In various embodiments, average profit margins for the one or more goods, services, and/or rights category are derived from data repositories, data sources, and/or companies providing the data needed to calculate the average profit margins for the one or more goods, services, and/or rights category.

In some embodiments, the platforms, systems, media, and methods described herein include an offer to buy from a buyer, or use of the same. In some embodiments, the calculated guidance is forced upon the buyer, wherein the platforms, systems, media, and methods choose to set the start price and/or reserve price on behalf of the buyer.

In some embodiments, the platforms, systems, media, and methods described herein include an offer to buy from a buyer, or use of the same. In some embodiments, guidance is provided in a forward auction, in which such guidance helps the bidder so that he/she does not bid too high (or set their proxy bid too high).

In some embodiments, the platforms, systems, media, and methods described herein include an offer to buy from a buyer, or use of the same. In some embodiments, guidance assists sellers with their pricing and gauging buyer demand at different price points.

In some embodiments, the platforms, systems, media, and methods described herein include an offer to buy from a buyer, or use of the same. In various embodiments, actions performed by the buyer are equated to a monetary value. In various embodiments, the monetary value of the action is disclosed to the buyer. In various embodiments, the monetary value of the action is not disclosed to the buyer. In various embodiments, the monetary value is assigned by the buyer and/or assigned by the seller. In various embodiments, the monetary value is at least a portion of a going price of one or more goods, services, and/or rights, at least a portion of a going price for an online purchase of one or more goods, services, and/or rights, and/or at least a portion of a list price of one or more goods, services, and/or rights. In various embodiments, the monetary action comprises applying for a credit card, applying for a loan, applying for a loan with a particular lender, applying for a loan with a particular broker, signing up for a checking and/or savings account, reduced or free shipping rates, selection of shipping provider, delayed receipt of one or more goods, services, and/or rights, signing up for a service and/or subscription, signing up for a trial of a service and/or subscription, subscribing to a recurring purchase service, picking up one or more purchased goods in lieu of shipping, providing a tool/instrument with which to perform the service, interacting with online affiliate advertising and/or marketing, taking a survey, taking a questionnaire, playing a game, answering a question, watching a video, watching an advertisement, listening to an advertisement, listening to a recording, or a combination thereof. In various embodiments, the monetary action further comprises reducing the number of shipments, deliveries, service calls, and/or visits by combining items with the same seller and/or different seller(s) into fewer shipments, deliveries, service calls, and/or visits, respectively.

In some embodiments, the platforms, systems, media, and methods described herein include an offer to buy from a buyer, or use of the same. In various embodiments, actions performed by the buyer are equated to a monetary value. In various embodiments, monetary actions are used as a discount to the purchase price for the buyer. As a non-limiting example, a buyer purchasing a good, service, and/or right offers to apply for a credit card in return for a discount of $40. As an additional non-limiting example, a buyer accepts a $12 discount in return for picking up the item in lieu of having it shipped. As an additional non-limiting example, a buyer requests a discount in return for the buyer subscribing to a recurring order of one or more items.

In some embodiments, the platforms, systems, media, and methods described herein include a reverse auction environment, or use of the same. In various embodiments, when a binding purchase between a buyer and one or more sellers is effectuated, the buyer's verified funds are automatically transferred to the one or more sellers such that the buyer and/or the seller cannot modify the purchase. In various embodiments, when a binding purchase between a buyer and one or more sellers is effectuated, the buyer and/or the seller is able to modify the purchase such that the purchase price is increased or decreased. In further or additional embodiments, when the purchase price is increased the buyer authorizes additional funds be transferred to the seller. In further or additional embodiments, when the purchase price is decreased the seller authorizes a refund of the amount of price decrease to the buyer. In various embodiments, when a binding purchase between a buyer and one or more sellers is effectuated, the buyer and/or the seller is able to modify the purchase such that one or more additional goods, services, and/or rights are purchased. In further or additional embodiments, when the buyer purchases one or more additional goods, services, and/or rights, the buyer authorizes funds to be transferred to the seller for the purchase price of the one or more additional goods, services, and/or rights. In various embodiments, when a binding purchase between a buyer and one or more sellers is effectuated, the buyer and/or the seller agree to mutually nullify the purchase such that the purchase is no longer binding. In further or additional embodiments, when the buyer and/or the seller agree to mutually nullify the purchase, the funds are not transferred from the buyer to the seller and/or the funds are refunded to the buyer. In further or additional embodiments, when the buyer and/or the seller agree to mutually nullify the purchase, the one or more goods, services, and/or rights are returned to the seller and/or the one or more goods and/or rights are not sent by the seller. In further or additional embodiments, when the buyer and/or the seller agree to mutually nullify the purchase, the one or more services are not provided by the seller. In various embodiments, nullifying and/or modifying a binding purchase is governed by local law, municipal law, city law, state law, U.S.A. law, laws of a foreign jurisdiction, international law, or a combination thereof. In further or additional embodiments, a law is an ordinance and/or a rule.

### Verification of Funds

In some embodiments, the platforms, systems, media, and methods described herein include a software module configured to verify availability of buyer funds, or use of the same. In various embodiments, availability of buyer funds to effectuate the proposed purchase price is verified. In further or additional embodiments, the proposed purchase price is sufficient to purchase one or more goods, services, and/or rights.

In some embodiments, the platforms, systems, media, and methods described herein include a software module configured to verify availability of buyer funds, or use of the same. In various embodiments, verification of availability of buyer funds is performed by ensuring a buyer's credit card is valid for payment to the seller. In various embodiments, verification of availability of buyer funds is performed by ensuring a buyer's credit card is valid for payment to the seller and the credit card has enough credit to equivalent to at least a portion of the buyer funds. In further or additional embodiments, verification a buyer's credit card is valid for payment to the seller comprises placing a hold on the buyer's credit card. In further or additional embodiments, placing a hold on the buyer's credit card is an authorization hold, a credit card authorization, a preauthorization, or a preauth. In further or additional embodiments, the hold on the buyer's credit card is maintained throughout the duration of the reverse auction. In further or additional embodiments, the hold on the buyer's credit card is for a time period shorter than the duration of the reverse auction. In further or additional embodiments, the hold on the buyer's credit card is shorter than the duration of the reverse auction because the duration of the reverse auction is longer than the amount of time permitted for a hold on the credit card. When the hold on the buyer's credit card is for a time period shorter than the duration of the reverse auction, in some embodiments, an additional hold is placed on the credit card. In various embodiments, the additional hold is long enough in duration such that one or more holds are placed on the buyer's credit card throughout the duration of the reverse auction. When the hold on the buyer's credit card is for a time period shorter than the duration of the reverse auction, in some embodiments, a plurality of additional holds are placed on the buyer's credit card, the plurality of additional holds being sequential in time and/or partially overlapping in time such that one or more holds are placed on the buyer's credit card throughout the duration of the reverse auction.

In some embodiments, the platforms, systems, media, and methods described herein include a software module configured to verify availability of buyer funds, or use of the same. In various embodiments, verification of availability of buyer funds is performed by ensuring a buyer's checking and/or savings account is valid for payment to the seller. In various embodiments, verification of availability of buyer funds is performed by ensuring a buyer's checking and/or savings account contains the requisite funds to execute payment with a debit card and/or electronic funds transfer, and thus provide payment to the seller. In further or additional embodiments, verification of availability of buyer funds comprises placing a hold on the buyer's checking account, debit card, and/or savings account. In further or additional embodiments, placing a hold on the buyer's checking account, debit card, and/or savings account is an authorization hold, a checking account, debit card, and/or savings account authorization, a preauthorization, or a preauth. In further or additional embodiments, the hold on the buyer's checking account, debit card, and/or savings account is maintained throughout the duration of the reverse auction. In further or additional embodiments, the hold on the buyer's checking account, debit card, and/or savings account is for a time period shorter than the duration of the reverse auction. In further or additional embodiments, the hold on the buyer's checking account, debit card, and/or savings account is shorter than the duration of the reverse auction because the duration of the reverse auction is longer than the amount of time permitted for a hold on the checking account, debit card, and/or savings account. When the hold on the buyer's checking account, debit card, and/or savings account is for a time period shorter than the duration of the reverse auction, in some embodiments, an additional hold is placed on the checking account, debit card, and/or savings account. In various embodiments, the additional hold is long enough in duration such that one or more holds are placed on the buyer's checking account, debit card, and/or savings account throughout the duration of the reverse auction. When the hold on the buyer's checking account, debit card, and/or savings account is for a time period shorter than the duration of the reverse auction, in some embodiments, a plurality of additional holds are placed on the buyer's checking account, debit card, and/or savings account, the plurality of additional holds being sequential in time and/or partially overlapping in time such that one or more holds are placed on the buyer's checking account, debit card, and/or savings account throughout the duration of the reverse auction.

In some embodiments, the platforms, systems, media, and methods described herein include a software module configured to verify availability of buyer funds, or use of the same. In various embodiments, verification of availability of buyer funds is performed by ensuring a buyer's checking and/or savings account is valid for payment to the seller. In various embodiments, the buyer authorizes the intermediary application to process payments through Automated Clearing House (ACH). When a buyer authorizes payments through ACH, in some embodiments, the buyer provides his checking and/or savings account information and authorizes the intermediary application to hold and/or withdraw funds on a one-time or ongoing basis. In various embodiments, verification of availability of buyer funds is performed by ensuring a buyer's checking and/or savings account contains the requisite funds to execute payment and thus provide payment to the seller. In further or additional embodiments, verification of availability of buyer funds comprises placing an ACH hold on the buyer's checking and/or savings account. In further or additional embodiments, the ACH hold on the buyer's checking and/or savings account is maintained throughout the duration of the reverse auction. In further or additional embodiments, the ACH hold on the buyer's checking and/or savings account is for a time period shorter than the duration of the reverse auction. In further or additional embodiments, the ACH hold on the buyer's checking and/or savings account is shorter than the duration of the reverse auction because the duration of the reverse auction is longer than the amount of time permitted for an ACH hold. When the ACH hold is for a time period shorter than the duration of the reverse auction, in some embodiments, an additional ACH hold is placed on the checking and/or savings account. In various embodiments, the additional ACH hold is long enough in duration such that one or more ACH holds are placed on the buyer's checking and/or savings account throughout the duration of the reverse auction. When the ACH hold is for a time period shorter than the duration of the reverse auction, in some embodiments, a plurality of additional ACH holds are placed on the buyer's checking and/or savings account, the plurality of additional ACH holds being sequential in time and/or partially overlapping in time such that one or more ACH holds are placed on the buyer's checking and/or savings account throughout the duration of the reverse auction.

In some embodiments, the platforms, systems, media, and methods described herein include a software module configured to verify availability of buyer funds, or use of the same. In various embodiments, verification of availability of buyer funds is performed by ensuring a buyer possesses the requisite digital cash to pay the seller. In various embodiments, verification of availability of buyer funds is performed by ensuring a buyer owns currency alternatives such as a cryptocurrency in order to pay the seller. In various embodiments, cryptocurrency comprises Bitcoin, Namecoin, Litecoin, Peercoin, Ripple, Mastercoin, Primecoin, Dogecoin, Darkcoin, Auroracoin, or a combination thereof. In various embodiments, verification of availability of buyer funds is performed by placing a hold on the buyer's electronic payment account, for example PayPal, Google Wallet, 2Checkout, Skrill, and Apple Pay.

In some embodiments, the platforms, systems, media, and methods described herein include a software module configured to verify availability of buyer funds, or use of the same. In various embodiments, verification of availability of buyer funds is performed using an escrow account associated with the buyer, wherein funds advanced by the buyer to cover the purchase of a desired one or more goods, services, and/or rights are held by a third party pending fulfillment by a qualified seller. In further or additional embodiments, when a seller wins a binding purchase offer, the funds are debited from the escrow account and remitted to the seller automatically. In various embodiments, the escrow account is held by a third party and/or the host of the intermediary application configured to provide a reverse auction environment. In various embodiments, the escrow account is held by a third party and/or the host of the intermediary application. In further or additional embodiments, the third party is a bank and/or an escrow company.

In some embodiments, the platforms, systems, media, and methods described herein include a software module configured to verify availability of buyer funds, or use of the same. In various embodiments, a buyer purchases one or more credits from an entity, and the credits are used to make a binding purchase to the intermediary application, therefore verifying the availability of buyer funds to pay the seller. In various embodiments, the credits are associated with a monetary value, for example about $1, about $2, about $3, about $4, about $5, about $10, about $20, about $50, about $100, about $500, about $1,000, about $5,000, about $10,000, about $50,000, about $100,000 or greater than about $100,000. In further or additional embodiments, currencies other than the dollar are used. In various embodiments, the entity is a third party, for example a private or public corporation and/or a bank. In various embodiments, the entity is the host of the intermediary application configured to provide a reverse auction. In various embodiments, when one or more sellers win the reverse auction, the seller is paid by the entity from which credits were purchased thereby guaranteeing payment from the buyer to the seller by entity.

In some embodiments, the platforms, systems, media, and methods described herein include a software module configured to verify availability of buyer funds, or use of the same. In further or additional embodiments, the proposed purchase price is a partial payment (e.g. a down payment) for one or more goods, services, and/or rights. In various embodiments, availability of buyer funds to effectuate the proposed purchase price, which is a partial payment, is verified. In further or additional embodiments, the portion of funds to effectuate the proposed purchase price is verified to effectuate a partial payment (e.g. a down payment) for one or more goods, services, and/or rights. In some embodiments, a proposed purchase requires a credit check and/or loan approval prior to executing the purchase. As a first non-limiting example, a buyer purchasing a $20,000 car proposes a down payment of 10% of the purchase price, and the platforms, systems, methods and media described herein verify the availability of $2000. As a second non-limiting example, a buyer purchasing a $20,000 car proposes a down payment of 10% of the purchase price, and the platforms, systems, methods and media described herein run a credit check and/or qualify a buyer for a loan of $18,000 as well as verifying the availability of $2000.

In some embodiments, the platforms, systems, media, and methods described herein include a software module configured to verify availability of buyer funds, or use of the same. In various embodiments, a buyer uses a plurality of payment methods to verify funds. In further or additional embodiments, one or more of the plurality of payment methods are used to verify at least a portion of the proposed purchase price and/or at least a portion of the reserve price. In further or additional embodiments, a buyer uses one or more of a credit card, a checking account, a savings account, an escrow account, digital currency, cryptocurrency, and credits to verify funds.

### Bids to Sell

In some embodiments, the platforms, systems, media, and methods described herein include bids from qualified sellers to sell one or more items in the offer to buy, or use of the same. In various embodiments, a buyer inputs seller criteria that specify seller requirements. In various embodiments, seller criteria comprise a bid price for one or more goods, services, and/or rights for which a buyer has placed an offer. In various embodiments, seller criteria comprise a lowest price the seller is willing to offer on one or more goods, services and/or rights. In various embodiments, seller criteria comprise secondary variables such as the minimum and maximum quantity available, geographic locations the seller is willing to sell to, geographic locations the seller is willing to ship to, time the one or more goods, services, and/or rights is available, a percentage or fixed dollar amount below or above other competitors the seller is willing to accept, one or more time periods in the auction to bid, length of time the bid is valid, delivery/fulfillment requirements, a seller reputation, ranking, rating, review score(s), number of previous sales, payment methods accepted, condition of previously delivered items, location, speed of delivery, local delivery availability, local pickup availability, and auxiliaries such as warranties and/or guarantees. Those of skill in the art will recognize that criteria not disclosed herein are, in some embodiments, useful to specify seller requirements. In further or additional embodiments, one or more time periods in the auction to bid comprise one or more seconds, minutes, hours, weeks, months, quarters, and/or years. In further or additional embodiments, one or more time periods in the auction to bid comprise less than one second, for example a femtosecond(s), a picosecond(s), a nanosecond(s), a microsecond(s), and/or a millisecond(s). In further or additional embodiments, one or more time periods in the auction to bid comprise a time in which to place a bid, for example a first bid in the reverse auction or a last bid in the reverse auction. In further or additional embodiments, the length of time the bid is valid comprises one or more seconds, minutes, hours, days, weeks, months, and/or years. In further or additional embodiments, the length of time the bid is valid comprises one or more femtoseconds, picoseconds, nanoseconds, microseconds, and/or milliseconds. In further or additional embodiments, delivery/fulfillment requirements comprise a fastest speed the seller promises to deliver the one or more goods and/or fulfill the service request.

In some embodiments, the platforms, systems, media, and methods described herein include bids from qualified sellers to sell one or more items in the offer to buy, or use of the same. In various embodiments, a buyer inputs seller criteria that specify seller requirements. In various embodiments, seller criteria comprise a bid price for one or more goods, services, and/or rights for which a buyer has placed an offer. In various embodiments, seller criteria comprise a lowest price the seller is willing to offer on one or more goods, services and/or rights. In various embodiments, seller criteria comprise secondary variables such as the minimum and maximum quantity available, geographic locations the seller is willing to sell to, geographic locations the seller is willing to ship to, time the one or more goods, services, and/or rights is available, a percentage or fixed dollar amount below or above other competitors the seller is willing to accept, one or more time periods in the auction to bid, length of time the bid is valid, delivery/fulfillment requirements, a seller reputation, ranking, rating, review score(s), number of previous sales, payment methods accepted, condition of previously delivered items, location, speed of delivery, local delivery availability, local pickup availability, and auxiliaries such as warranties and/or guarantees. Those of skill in the art will recognize that criteria not disclosed herein are, in some embodiments, useful to specify seller requirements. In some embodiments, the intermediary application comprises a software module to place instant bids. In various embodiments, instant bids are placed on behalf of one or more sellers. In various embodiments, instant bids on behalf of a first seller are derived from one or more additional seller's bids and/or instant bids. In further or additional embodiments, the instant bids on behalf of the first seller are a percentage and/or fixed dollar amount lower or higher (i.e. a lower selling price or a higher selling price) than one or more additional seller's bids and/or instant bids. In various embodiments, instant bids are based on satisfying one or more seller criteria specified by the buyer, the seller criteria stored in a database by the intermediary application and/or monitored in real time by the intermediary application. As a non-limiting example, in addition to the seller criteria stated above, seller criteria comprising an item and the bid price and/or bottom-line price are stored in a database. Further as a non-limiting example, the instant bid is a bid price below the offer price entered by the buyer. In further or additional embodiments, when seller criteria are satisfied by one or more instant bids, the reverse auction ends. In further or additional embodiments, instant bids are placed in an “instant” reverse auction. In further or additional embodiments, satisfying the seller criteria requires satisfying a subset of the seller criteria specified by the buyer. In various embodiments, a buyer agrees that the reverse auction will be an instant auction. In various embodiments, in an instant auction, one or more instant bids are placed for an amount of time so as to satisfy seller criteria, thus the instant bids are not literally instant but rather are briefly active in the reverse auction. As a non-limiting example, the amount of time comprises one or more femtoseconds, picoseconds, nanoseconds, microseconds, milliseconds, and/or seconds. In further or additional embodiments, satisfying the seller criteria requires satisfying a subset of the seller criteria specified by the buyer

In further or additional embodiments, one or more time periods in the auction to bid comprise one or more seconds, minutes, hours, weeks, months, quarters, and/or years. In further or additional embodiments, one or more time periods in the auction to bid comprise less than one second, for example a femtosecond(s), a picosecond(s), a nanosecond(s), a microsecond(s), and/or a millisecond(s). In further or additional embodiments, one or more time periods in the auction to bid comprise a time in which to place a bid, for example a first bid in the reverse auction or a last bid in the reverse auction. In further or additional embodiments, the length of time the bid is valid comprises one or more seconds, minutes, hours, days, weeks, months, and/or years. In further or additional embodiments, the length of time the bid is valid comprises one or more femtoseconds, picoseconds, nanoseconds, microseconds, and/or milliseconds. In further or additional embodiments, delivery/fulfillment requirements comprise a fastest speed the seller promises to deliver the one or more goods and/or fulfill the service request.

In some embodiments, the platforms, systems, media, and methods described herein include bids from qualified sellers to sell one or more of the items in the offer to buy, or use of the same. In various embodiments, based on seller criteria, the intermediary application manages the reverse auction bids on behalf of the seller. In various embodiments, the intermediary application manages the reverse auction bids in a combination of reverse auctions, for example present and future auctions. In further or additional embodiments, the intermediary application manages the reverse auction bids in a combination of reverse auctions in order to fulfill the seller's availability of offers in accordance with the seller's criteria.

In some embodiments, the platforms, systems, media, and methods described herein include bids from qualified sellers to sell one or more of the items in the offer to buy, or use of the same. In various embodiments, when a buyer submits an offer to purchase one or more goods, services, and/or rights, the intermediary application contacts a seller, service provider, and/or rights holder. In further or additional embodiments, the seller, service provider, and/or rights holder is not in the database of qualified sellers. In various embodiments, the intermediary application contacts the seller, service provider, and/or rights holder because the database of qualified sellers does not contain a seller, service provider, and/or rights holder who sells one or more goods, services, and/or rights that the buyer offers to purchase.

In some embodiments, the platforms, systems, media, and methods described herein include bids from qualified sellers to sell one or more of the items in the offer to buy, or use of the same. In various embodiments, the seller with the lowest bid when the time period for the reverse auction ends wins the reverse auction. In various embodiments, one or more sellers choose to use limited time bids, which are bids that are valid for a time period less than the remaining time in the auction. In further or additional embodiments, the time period less than the remaining time in the auction comprises, about one minute, about two minutes, about three minutes, about four minutes, about five minutes, about six minutes, about seven minutes, about eight minutes, about nine minutes, about ten minutes, about fifteen minutes, about twenty minutes, about twenty-five minutes, about thirty minutes, about thirty-five minutes, about forty minutes, about forty-five minutes, about fifty minutes, about fifty-five minutes, about one hour, about two hours, about three hours, about four hours, about six hours, about seven hours, about eight hours, about nine hours, about ten hours, about eleven hours, about twelve hours, about thirteen hours, about fourteen hours, about fifteen hours, about sixteen hours, about seventeen hours, about eighteen hours, about nineteen hours, about twenty hours, about twenty-one hours, about twenty-two hours, about twenty-three hours, about one day, about two days, about three days, about four days, about five days, about six days, about one week, about two weeks, about three weeks, about one month, about two months, about three months, about four months, about five months, about six months, about seven months, about eight months, about nine months, about ten months, about eleven months, about one year, or greater than about one year.

In some embodiments, the platforms, systems, media, and methods described herein include bids from qualified sellers to sell one or more of the items in the offer to buy, or use of the same. In various embodiments, the seller with the lowest bid when the time period for the reverse auction ends wins the reverse auction. In various embodiments, one or more sellers choose to use limited time bids, which are bids that are valid for a time period less than the remaining time in the auction. In various embodiments, one or more sellers choose to use limited time bids, which are bids that are valid for a particular time period during a reverse auction. For example, in some embodiments, a limited time bid is valid only for a particular number of minute(s), hour(s), day(s), week(s), month(s), and/or year(s) during a reverse auction. In some embodiments, limited time bids are recurring during a reverse auction. In various embodiments, limited time bids recur every time a specified number of minute(s), hour(s), day(s), week(s), month(s), and/or year(s) go by when the reverse auction has been taking place. In various embodiments, limited time bids recur when a specified number of bids are placed in a reverse auction. In various embodiments, limited time bids expedite completion of the reverse auction. For example, instead of going through several rounds of bidding, sellers, in some embodiments, offer their “best and final” price upfront as an incentive for the buyer to choose their offer now. In various embodiments, limited time bids prevent underbidding by another seller. For example, in a reverse auction, in some embodiments, there is a risk that a seller will be underbid by another seller within mere seconds or minutes of the auction's close. In some embodiments, this practice is referred to as bid sniping, wherein a “sniper” (an under-bidding seller) undercuts the currently winning seller's bid by a small monetary amount (e.g. one or several pennies or other small amount). Further, in some embodiments, the “sniper” under-bids when there is so little time left in the auction that the previously winning seller does not have a chance to re-bid. Thus, by offering a limited time bid, a seller has a better opportunity of capturing the sale early, rather than losing out to a bid sniper at the end of the auction.

In some embodiments, the platforms, systems, media, and methods described herein include bids from qualified sellers to sell one or more of the items in the offer to buy, or use of the same. In various embodiments, the seller with the lowest bid when the time period for the reverse auction ends wins the reverse auction. In various embodiments, one or more sellers choose to use limited time bids, which are bids that are valid for a time period less than the remaining time in the auction. In various embodiments, one or more sellers choose to use limited time bids, which are bids that are valid for a particular time period during a reverse auction. For example, in some embodiments, a limited time bid is valid only for a particular number of minute(s), hour(s), day(s), week(s), month(s), and/or year(s) during a reverse auction. In various embodiments, impatient buyers choose to buy elsewhere, rather than wait for the auction to end. As such, a limited time bid provides impatient buyers an option to make a purchase quicker than waiting for the auction to end.

In some embodiments, the platforms, systems, media, and methods described herein include bids from qualified sellers to sell one or more of the items in the offer to buy, or use of the same. In various embodiments, the seller with the lowest bid when the time period for the reverse auction ends wins the reverse auction. In various embodiments, one or more sellers choose to use limited time bids, which are bids that are valid for a time period less than the remaining time in the auction. In various embodiments, one or more sellers choose to use limited time bids, which are bids that are valid for a particular time period during a reverse auction. For example, in some embodiments, a limited time bid is valid only for a particular number of minute(s), hour(s), day(s), week(s), month(s), and/or year(s) during a reverse auction. In various embodiments, sellers place one or more limited time bids manually or using a proxy. In various embodiments, when the one or more limited time bids are placed on behalf of the seller using the proxy, the one or more limited time bids are set as a percentage or fixed dollar amount below other sellers' pending bids. In various embodiments, when the one or more limited time bids are placed on behalf of the seller using the proxy, the one or more limited time bids are set as a percentage or fixed dollar amount below the seller's normal bid. In various embodiments, when the one or more limited time bids are placed on behalf of the seller using the proxy, the one or more limited time bids are set as a percentage or fixed dollar amount above other sellers' pending bids. In various embodiments, when the one or more limited time bids are placed on behalf of the seller using the proxy, the one or more limited time bids are set as a percentage or fixed dollar amount above the seller's normal bid.

In some embodiments, the platforms, systems, media, and methods described herein include bids from qualified sellers to sell one or more of the items in the offer to buy, or use of the same. In various embodiments, the seller with the lowest bid when the time period for the reverse auction ends wins the reverse auction. In various embodiments, one or more sellers choose to use limited time bids, which are bids that are valid for a time period less than the remaining time in the auction. In various embodiments, one or more sellers choose to use limited time bids, which are bids that are valid for a particular time period during a reverse auction. For example, in some embodiments, a limited time bid is valid only for a particular number of minute(s), hour(s), day(s), week(s), month(s), and/or year(s) during a reverse auction. In various embodiments, one or more limited time bids systematically change during the reverse auction. In further or additional embodiments, the one or more limited time bids systematically increase the selling price during the reverse auction. In further or additional embodiments, the one or more limited time bids systematically decrease a discount, for example a percent discount and/or a monetary value discount, on the buyer's offer price during the reverse auction. In further or additional embodiments, the percent discount and/or the monetary value discount is systematically decreased programmatically or manually by the seller. In further or additional embodiments, the percent discount is systematically decreased programmatically, for example by decreasing the discount about 1% per day of the reverse auction, about 2% per day of the reverse auction, about 3% per day of the reverse auction, about 4% per day of the reverse auction, about 5% per day of the reverse auction, about 6% per day of the reverse auction, about 7% per day of the reverse auction, about 8% per day of the reverse auction, about 9% per day of the reverse auction, about 10% per day of the reverse auction, about 15% per day of the reverse auction, about 20% per day of the reverse auction, about 25% per day of the reverse auction, about 30% per day of the reverse auction, about 35% per day of the reverse auction, about 40% per day of the reverse auction, about 45% per day of the reverse auction, about 50% per day of the reverse auction, or any percent per day of the reverse auction. As a non-limiting example, on the first day of the reverse auction, the limited time bid, in some embodiments, comprises a 10% discount, on the second day of the reverse auction, the limited time bid in some embodiments, comprises a 9% discount, on the third day of the reverse auction, the limited time bid, in some embodiments, comprises a 8% discount, and so forth. In further or additional embodiments, the aforementioned percent discounts systematically decrease per minute, per hour, per week, per month, per year, or a combination thereof. In various embodiments, the monetary value discount is systematically decreased per minute, per hour, per day, per week, per month, per year, or a combination thereof. In various embodiments, a diminishing discount is a discount that is systematically decreased during the reverse auction. In various embodiments, a diminishing discount incentivizes the buyer to accept the discounted price within the specified time period so as to end the auction earlier than the buyer otherwise would.

In some embodiments, the platforms, systems, media, and methods described herein include bids from qualified sellers to sell one or more of the items in the offer to buy, or use of the same. In various embodiments, the seller with the lowest bid when the time period for the reverse auction ends wins the reverse auction. In various embodiments, one or more sellers choose to use limited time bids, which are bids that are valid for a time period less than the remaining time in the reverse auction. In various embodiments, one or more sellers choose to use limited time bids, which are bids that are valid for a particular time period during a reverse auction. For example, in some embodiments, a limited time bid is valid only for a particular number of minute(s), hour(s), day(s), week(s), month(s), and/or year(s) during a reverse auction. In various embodiments, the limited time bid is derived based on another bid. In various embodiments, the limited time bid is based on another seller's bid such that the limited time bid is a percentage and/or a monetary amount less than another seller's bid and is valid for a time period less than the remaining time in the reverse auction. In further or additional embodiments, the limited time bid is based on another seller's bid such that the limited time bid is about 1% less than another seller's bid, about 2% less than another seller's bid, about 3% less than another seller's bid, about 4% less than another seller's bid, about 5% less than another seller's bid, about 6% less than another seller's bid, about 7% less than another seller's bid, about 8% less than another seller's bid, about 9% less than another seller's bid, about 10% less than another seller's bid, about 15% less than another seller's bid, about 20% less than another seller's bid, about 25% less than another seller's bid, about 30% less than another seller's bid, about 35% less than another seller's bid, about 40% less than another seller's bid, about 45% less than another seller's bid, about 50% less than another seller's bid, or any percent less than another seller's bid. As a non-limiting example, a currently winning bid in an auction is $92 and the limited time bid is specified programmatically to be a percentage lower (e.g. 1% less or $91.08) or a fixed dollar amount below (e.g. $1 less or $91). In various embodiments, the limited time bid derived based on another bid is specified to be active during one or more time periods of an auction.

In some embodiments, the platforms, systems, media, and methods described herein include bids from qualified sellers to sell one or more of the items in the offer to buy, or use of the same. In various embodiments, the seller with the lowest bid when the time period for the reverse auction ends wins the reverse auction. In various embodiments, one or more sellers choose to use limited time bids, which are bids that are valid for a time period less than the remaining time in the reverse auction. In various embodiments, one or more sellers choose to use limited time bids, which are bids that are valid for a particular time period during a reverse auction. For example, in some embodiments, a limited time bid is valid only for a particular number of minute(s), hour(s), day(s), week(s), month(s), and/or year(s) during a reverse auction. In various embodiments, the limited time bid is derived based on another bid. In various embodiments, the limited time bid is based on another seller's bid such that the limited time bid is a percentage and/or a monetary amount more than another seller's bid and is valid for a time period less than the remaining time in the reverse auction. In further or additional embodiments, the limited time bid is based on another seller's bid such that the limited time bid is about 1% more than another seller's bid, about 2% more than another seller's bid, about 3% more than another seller's bid, about 4% more than another seller's bid, about 5% more than another seller's bid, about 6% more than another seller's bid, about 7% more than another seller's bid, about 8% more than another seller's bid, about 9% more than another seller's bid, about 10% more than another seller's bid, about 15% more than another seller's bid, about 20% more than another seller's bid, about 25% more than another seller's bid, about 30% more than another seller's bid, about 35% more than another seller's bid, about 40% more than another seller's bid, about 45% more than another seller's bid, about 50% more than another seller's bid, or any percent more than another seller's bid. As a non-limiting example, a currently winning bid in an auction is $92 and the limited time bid is specified programmatically to be a percentage higher (e.g. 1% higher or $92.92) or a fixed dollar amount above (e.g. $1 higher or $93). In various embodiments, the limited time bid derived based on another bid is specified to be active during one or more time periods of an auction.

In some embodiments, the platforms, systems, media, and methods described herein include bids from qualified sellers to sell one or more of the items in the offer to buy, or use of the same. In various embodiments, the seller with the lowest bid when the time period for the reverse auction ends wins the reverse auction. In various embodiments, one or more sellers choose to use limited time bids, which are bids that are valid for a time period less than the remaining time in the reverse auction. In various embodiments, one or more sellers choose to use limited time bids, which are bids that are valid for a particular time period during a reverse auction. For example, in some embodiments, a limited time bid is valid only for a particular number of minute(s), hour(s), day(s), week(s), month(s), and/or year(s) during a reverse auction. In various embodiments, the limited time bid is derived based on another bid. In various embodiments, the limited time bid is based on another seller's bid such that the limited time bid is a percentage and/or a monetary amount less than another seller's bid and is valid for a time period less than the remaining time in the reverse auction. In some embodiments, a reputable seller will set a bottom-line price below which they will not place a limited time bid. In various embodiments, the price is set because the reputable seller believes his one or more goods, services, and/or rights are worth at least the price. In further or additional embodiments, this prevents dishonest sellers/persons from driving the price of one or more goods, services, and/or rights artificially low.

In some embodiments, the platforms, systems, media, and methods described herein include bids from qualified sellers to sell one or more of the items in the offer to buy, or use of the same. In various embodiments, the seller with the lowest bid when the time period for the reverse auction ends wins the reverse auction. In various embodiments, one or more sellers choose to use limited time bids, which are bids that are valid for a time period less than the remaining time in the reverse auction. In various embodiments, one or more sellers choose to use limited time bids, which are bids that are valid for a particular time period during a reverse auction. For example, in some embodiments, a limited time bid is valid only for a particular number of minute(s), hour(s), day(s), week(s), month(s), and/or year(s) during a reverse auction. In various embodiments, the limited time bid is derived based on another bid. In various embodiments, the limited time bid is based on another seller's bid such that the limited time bid is a percentage and/or a monetary amount higher than another seller's bid and is valid for a time period less than the remaining time in the reverse auction. In some embodiments, a reputable seller will set a bottom-line price below which they will not place a limited time bid. In various embodiments, the price is set because the reputable seller believes his one or more goods, services, and/or rights are worth at least the price. In further or additional embodiments, this prevents dishonest sellers/persons from driving the price of one or more goods, services, and/or rights artificially low. In various embodiments, a seller will place a limited time bid with a price greater than a price offered by a less reputable and/or less desirable seller.

In some embodiments, the platforms, systems, media, and methods described herein include an offer to buy from a buyer, or use of the same. In various embodiments, actions performed by the buyer are equated to a monetary value. In various embodiments, the monetary value of the action is disclosed to the buyer. In various embodiments, the monetary value of the action is not disclosed to the buyer. In various embodiments, the monetary value is assigned by the buyer and/or assigned by the seller. In various embodiments, the monetary value is at least a portion of a going price of the good, service, and/or right, at least a portion of a going price for an online purchase of the good, service, and/or right, and/or at least a portion of a list price of the good, service, and/or right. In various embodiments, the monetary action comprises applying for a credit card, applying for a loan, applying for a loan with a particular lender, applying for a loan with a particular broker, signing up for a checking and/or savings account, reduced or free shipping rates, selection of shipping provider, delayed receipt of one or more goods, services, and/or rights, signing up for a service and/or subscription, signing up for a trial of a service and/or subscription, subscribing to a recurring purchase service, picking up one or more purchased goods in lieu of shipping, providing a tool/instrument with which to perform the service, interacting with online affiliate advertising and/or marketing, taking a survey, taking a questionnaire, playing a game, answering a question, watching a video, watching an advertisement, listening to an advertisement, listening to a recording, or a combination thereof. In various embodiments, the monetary action further comprises reducing the number of shipments, deliveries, service calls, and/or visits by combining items with the same seller and/or different seller(s) into fewer shipments, deliveries, service calls, and/or visits, respectively.

In some embodiments, the platforms, systems, media, and methods described herein include an offer to buy from a buyer, or use of the same. In various embodiments, actions performed by the buyer are equated to a monetary value. In various embodiments, the monetary value of the action is not disclosed to the buyer. In further or additional embodiments, when the monetary value of the action is not disclosed to the buyer, the monetary action is included with the seller's bid. In further or additional embodiments, the monetary action is included by a first seller with the seller's bid by or on behalf of a second seller who is selling the monetary action. In various embodiments, not disclosing the value of a monetary action allows a seller to not disclose profit margins on selling one or more goods, services, and/or rights. In various embodiments, not disclosing the value of a monetary action allows a seller to make the bid more attractive to a buyer as the price of the one or more goods, services, and/or rights appears effectively lower. In various embodiments, bidding a lower price and not disclosing the value of a monetary action allows a seller to make the bid more attractive to a buyer purchasing one or more goods, services, and/or rights from the seller because the bid appears to be a cheaper price for the buyer. However, in some embodiments, the buyer offsets the lower price by performing an action with a monetary value.

In some embodiments, the platforms, systems, media, and methods described herein include an offer to buy from a buyer, or use of the same. In various embodiments, actions performed by the buyer are equated to a monetary value. In various embodiments, the monetary value of the action is not disclosed to the buyer. In various embodiments a seller includes a monetary action in the bid in order to lower the buyer's perceived price. As a non-limiting example, a first seller is trying to outbid a second seller by offering a lower price. In order for the second seller to offer the same or a lower price, the second seller includes with the bid a monetary action in order to offset the lower price offered to the buyer. In further or additional embodiments, a seller trying to outbid another seller is a less reputable and/or less desirable.

In some embodiments, the platforms, systems, media, and methods described herein include an offer to buy from a buyer, or use of the same. In various embodiments, actions performed by the buyer are equated to a monetary value. In various embodiments, the monetary value of the action is not disclosed to the buyer. In various embodiments, a seller has a pre-defined bottom-line price, wherein the bottom-line price is a price below which they will not and/or do not intend to sell one or more goods, services, and/or rights. In further or additional embodiments, offering a monetary action allows the seller to offer a perceived price to the buyer that is lower than the bottom-line price and offset the lower price with the value of the monetary action. In some embodiments, the platforms, systems, media, and methods described herein include an offer to buy from a buyer, or use of the same. In various embodiments, actions performed by the buyer are equated to a monetary value. In various embodiments, the monetary value of the action is not disclosed to the buyer. In various embodiments, a seller offers a monetary action in order to “sweeten” the bid to entice the buyer to select the bid. In various embodiments, the monetary action to “sweeten” the deal comprises applying for a credit card with a reduced interest rate, applying for a loan with a reduced interest rate, reduced or free shipping rates, shipping by a particular shipping provider, a cheaper price in return for delayed receipt of one or more goods, services, and/or rights, reducing the number of shipments, deliveries, service calls, and/or visits by combining items with the same seller and/or different seller(s) into fewer shipments, deliveries, service calls, and/or visits, respectively, offering a free trial of a service and/or subscription, or a combination thereof.

In some embodiments, the platforms, systems, media, and methods described herein include an offer to buy from a buyer, or use of the same. In various embodiments, actions performed by the buyer are equated to a monetary value. In various embodiments, monetary actions are used as a discount to the purchase price for the buyer. As a non-limiting example, a buyer purchasing a good, service, and/or right agrees to apply for a credit card in return for a discount of $40. As an additional non-limiting example, a buyer accepts a $12 discount in return for picking up the item in lieu of having it shipped. As an additional non-limiting example, a buyer accepts a discount in return for the buyer subscribing to a recurring order of one or more items.

### Selection of Sellers

In some embodiments, the platforms, systems, media, and methods described herein include a software module configured to select one or more bidding sellers, or use of the same. In various embodiments, a seller with the lowest bid at the end of the reverse auction is selected by the software module. In some embodiments, a seller is selected by the software module based on one or more of a seller reputation, ranking, rating, review score(s), number of previous sales, payment methods accepted, condition of previously delivered items, location, speed of delivery, local delivery availability, local pickup availability, and auxiliaries such as warranties and/or guarantees. In some embodiments, a seller is selected by the software module based on the bid placed by the seller and one or more of a seller reputation, ranking, rating, review score(s), number of previous sales, payment methods accepted, condition of previously delivered items, location, speed of delivery, local delivery availability, local pickup availability, and auxiliaries such as warranties and/or guarantees. In further or additional embodiments, the seller reputation is based on reviews and/or ratings from review websites such as Yelp and Angie's List. In further or additional embodiments, the seller reputation is reviews such as consumer reports, for example the corporation Consumer Reports. In various embodiments, a seller ranking is the same as a seller reputation. In various embodiments, a seller ranking is based on historical sales data compiled by the host of the intermediary application configured to provide a reverse auction. In various embodiments, a seller ranking is based on sales data compiled by one or more web marketplaces such as Amazon and/or eBay.

In some embodiments, the platforms, systems, media, and methods described herein include a software module configured to select one or more bidding sellers, or use of the same. In various embodiments, a buyer selects the winning seller of the reverse auction. In various embodiments, when the buyer is selecting the winner of the reverse auction, as long as the one or more buyer's criteria for winning the auction is satisfied, the sale is binding to the buyer. In further or additional embodiments, satisfying the buyer's criteria requires satisfying a subset of the buyer's criteria specified by the buyer. In various embodiments, a seller with the lowest bid at the end of the reverse auction is selected. In various embodiments, a seller is selected based on one or more of a seller reputation, ranking, rating, review score(s), number of previous sales, payment methods accepted, condition of previously delivered items, location, speed of delivery, local delivery availability, local pickup availability, and auxiliaries such as warranties and/or guarantees. In various embodiments, when selecting a seller, the buyer considers the bid placed by the seller and one or more of a seller reputation, ranking, rating, review score(s), number of previous sales, payment methods accepted, condition of previously delivered items, location, speed of delivery, local delivery availability, local pickup availability, and auxiliaries such as warranties and/or guarantees. In further or additional embodiments, the seller reputation is based on reviews and/or ratings from review websites such as Yelp and Angie's List. In further or additional embodiments, the seller reputation is reviews such as consumer reports, for example the corporation Consumer Reports. In various embodiments, a seller ranking is the same as a seller reputation. In various embodiments, a seller ranking is based on historical sales data compiled by the host of the intermediary application configured to provide a reverse auction. In various embodiments, a seller ranking is based on sales data compiled by one or more web marketplaces such as Amazon and/or eBay.

In some embodiments, the platforms, systems, media, and methods described herein include a software module configured to select one or more bidding sellers, or use of the same. In various embodiments, a seller with the lowest bid at the end of the reverse auction is selected by the software module. In various embodiments, the software module selects a seller based on one or more of a seller reputation, ranking, rating, review score(s), number of previous sales, payment methods accepted, condition of previously delivered items, location, speed of delivery, local delivery availability, local pickup availability, and auxiliaries such as warranties and/or guarantees. In various embodiments, a seller is selected by the software module based on the bid placed by the seller and one or more of a seller reputation, ranking, rating, review score(s), number of previous sales, payment methods accepted, condition of previously delivered items, location, speed of delivery, local delivery availability, local pickup availability, and auxiliaries such as warranties and/or guarantees. In further or additional embodiments, the seller rating, one or more review scores of a seller, are based on reviews on the website of the host of intermediary application configured to provide a reverse auction. In further or additional embodiments, the seller rating, one or more review scores of a seller are obtained from external review websites.

In some embodiments, the platforms, systems, media, and methods described herein include a software module configured to select one or more bidding sellers, or use of the same. In various embodiments, a buyer selects the winning seller of the reverse auction. In various embodiments, when the buyer is selecting the winner of the reverse auction, as long as the buyer's criteria for winning the auction are satisfied, the sale is binding to the buyer. In further or additional embodiments, satisfying the buyer's criteria requires satisfying a subset of the buyer's criteria specified by the buyer. In various embodiments, a seller with the lowest bid at the end of the reverse auction is selected. In various embodiments, a buyer selects a seller based on one or more of a seller reputation, ranking, rating, review score(s), number of previous sales, payment methods accepted, condition of previously delivered items, location, speed of delivery, local delivery availability, local pickup availability, and auxiliaries such as warranties and/or guarantees. In various embodiments, when selecting a seller, the buyer considers the bid placed by the seller and one or more of a seller reputation, ranking, rating, review score(s), number of previous sales, payment methods accepted, condition of previously delivered items, location, speed of delivery, local delivery availability, local pickup availability, and auxiliaries such as warranties and/or guarantees. In further or additional embodiments, the seller rating and/or one or more review scores of a seller are based on reviews on the website of the host of intermediary application configured to provide a reverse auction. In further or additional embodiments, the seller rating, one or more review scores of a seller are obtained from external review websites.

In some embodiments, the platforms, systems, media, and methods described herein include a software module configured to select one or more bidding sellers, or use of the same. In various embodiments, a seller with the lowest bid at the end of the reverse auction is selected by the software module. In various embodiments, the software module selects a seller based on the bid placed by the seller and/or one or more of a seller reputation, ranking, rating, review score(s), number of previous sales, payment methods accepted, condition of previously delivered items, location, speed of delivery, local delivery availability, local pickup availability, and auxiliaries such as warranties and/or guarantees. In various embodiments, a seller is selected based on the proximity to the location in which the buyer is located, for example in the same neighborhood, zip code, village, town, city, county, state, and/or country. In various embodiments, a qualified seller is available for local delivery and/or local pickup when the seller is in close proximity to the location in which the buyer is located, for example in the same neighborhood, zip code, village, town, city, county, state, and/or country. In further or additional embodiments, a seller in closer proximity to the buyer is selected. In various embodiments, the location of the seller is not important as long as the seller is willing to ship the one or more goods and/or fulfill the one or more services. In various embodiments, the speed of delivery is used to select a seller. In further or additional embodiments, the speed of delivery from the seller is stated by the seller. In further or additional embodiments, the speed of delivery from the seller is based on reviews and/or ratings from review websites such as Yelp and Angie's List. In further or additional embodiments, the speed of delivery from the seller is based on reviews such as consumer reports, for example the corporation Consumer Reports. In various embodiments, the speed of delivery from the seller is based on data compiled by one or more web marketplaces such as Amazon and/or eBay. In various embodiments, auxiliaries such as warranties and/or guarantees are used to select a seller. In further or additional embodiments, auxiliaries are offered by the seller. In some embodiments, auxiliaries offered by the seller are incentives for a buyer to accept the seller's bid.

In some embodiments, the platforms, systems, media, and methods described herein include a software module configured to select one or more bidding sellers, or use of the same. In various embodiments, a buyer selects the winning seller of the reverse auction. In various embodiments, when the buyer is selecting the winner of the reverse auction, as long as the buyer's criteria for winning the auction are satisfied, the sale is binding to the buyer. In further or additional embodiments, satisfying the buyer's criteria requires satisfying a subset of the buyer's criteria specified by the buyer. In various embodiments, when selecting a seller, the buyer considers the bid placed by the seller and/or one or more of a seller reputation, ranking, rating, review score(s), number of previous sales, payment methods accepted, condition of previously delivered items, location, speed of delivery, local delivery availability, local pickup availability, and auxiliaries such as warranties and/or guarantees. In various embodiments, a seller is selected based on the proximity to the location in which the buyer is located, for example in the same neighborhood, zip code, village, town, city, county, state, and/or country. In various embodiments, a qualified seller is available for local delivery and/or local pickup when the seller is in close proximity to the location in which the buyer is located, for example in the same neighborhood, zip code, village, town, city, county, state, and/or country. In further or additional embodiments, a seller in closer proximity to the buyer is selected. In various embodiments, the location of the seller is not important as long as the seller is willing to ship the one or more goods and/or fulfill the one or more services. In various embodiments, the speed of delivery is used to select a seller. In further or additional embodiments, the speed of delivery from the seller is stated by the seller. In further or additional embodiments, the speed of delivery from the seller is based on reviews and/or ratings from review websites such as Yelp and Angie's List. In further or additional embodiments, the speed of delivery from the seller is based on reviews such as consumer reports, for example the corporation Consumer Reports. In various embodiments, the speed of delivery from the seller is based on data compiled by one or more web marketplaces such as Amazon and/or eBay. In various embodiments, auxiliaries such as warranties and/or guarantees are used to select a seller. In further or additional embodiments, auxiliaries are offered by the seller. In some embodiments, auxiliaries offered by the seller are incentives for a buyer to accept the seller's bid.

In some embodiments, the platforms, systems, media, and methods described herein include a reverse auction environment, or use of the same. In various embodiments, when a binding purchase between a buyer and one or more sellers is effectuated, the buyer's verified funds are automatically transferred to the one or more sellers such that the buyer and/or the seller cannot modify the purchase. In various embodiments, when a binding purchase between a buyer and one or more sellers is effectuated, the buyer and/or the seller is able to modify the purchase such that the purchase price is increased or decreased. In further or additional embodiments, when the purchase price is increased the buyer authorizes additional funds be transferred to the seller. In further or additional embodiments, when the purchase price is decreased the seller authorizes a refund of the amount of price decrease to the buyer. In various embodiments, when a binding purchase between a buyer and one or more sellers is effectuated, the buyer and/or the seller is able to modify the purchase such that one or more additional goods, services, and/or rights are purchased. In further or additional embodiments, when the buyer purchases one or more additional goods, services, and/or rights, the buyer authorizes funds to be transferred to the seller for the purchase price of the one or more additional goods, services, and/or rights. In various embodiments, when a binding purchase between a buyer and one or more sellers is effectuated, the buyer and/or the seller agree to mutually nullify the purchase such that the purchase is no longer binding. In further or additional embodiments, when the buyer and/or the seller agree to mutually nullify the purchase, the funds are not transferred from the buyer to the seller and/or the funds are refunded to the buyer. In further or additional embodiments, when the buyer and/or the seller agree to mutually nullify the purchase, the one or more goods, services, and/or rights are returned to the seller and/or the one or more goods and/or rights are not sent by the seller. In further or additional embodiments, when the buyer and/or the seller agree to mutually nullify the purchase, the one or more services are not provided by the seller. In various embodiments, nullifying and/or modifying a binding purchase is governed by local law, municipal law, city law, state law, U.S.A. law, laws of a foreign jurisdiction, international law, or a combination thereof. In further or additional embodiments, a law is an ordinance and/or a rule.

### Dynamic Item and Price Allocation

In some embodiments, the platforms, systems, media, and methods described herein include a software module configured to dynamically allocate sale of each item to one or more selected sellers, or use of the same. In some embodiments, the software module configured to dynamically allocate sale of each item to one or more selected sellers manages one or more sellers' bids. In further or additional embodiments, the one or more sellers' bids are managed in a manner that intentionally violates the one or more sellers' specifications but does not cause the one or more sellers' to endure a financial loss as a result of violating the one or more sellers' specifications. In a first non-limiting example, the intermediary application places a bid on behalf of a first seller that is below the first seller's lowest specified bid; with the intention that the difference will be rectified by other methods (e.g. the host of the intermediary application will absorb the financial difference). In a second non-limiting example, the intermediary application intentionally overcommits a first seller because the intermediary application approximates that the seller will lose a proportion of the reverse auction in which bids are placed (e.g. bids on behalf of the seller in 100 auctions when the seller only has a quantity of 10 available, because the algorithm determines that the seller will lose at least 90 of the auctions).

In some embodiments, the platforms, systems, media, and methods described herein include a software module configured to dynamically allocate sale of each item to one or more selected sellers, or use of the same. In some embodiments, the software module configured to dynamically allocate sale of each item to one or more selected sellers manages one or more sellers' bids. In further or additional embodiments, the one or more sellers' bids are managed in a manner that intentionally violates the one or more sellers' specifications but does not cause the one or more sellers' to endure a financial loss as a result of violating the one or more sellers' specifications. In various embodiments, bids are placed on behalf of one or more sellers such that the distribution of prices for which the seller sells goods and/or provides services at least approximately follows a bell curve (e.g. a normal distribution). In various embodiments, a bell curve is a Gaussian distribution.

In some embodiments, the platforms, systems, media, and methods described herein include a software module configured to dynamically allocate sale of each item to one or more selected sellers, or use of the same. In various embodiments, the intermediary application autonomously mixes and matches bids from a plurality of sellers in order to fulfill the offers of one or more buyers. In some embodiments, the combined sales are itemized when presented to the buyer. In some embodiments, the buyer is blind to a breakdown of pricing. In some embodiments, the buyer is blind to a breakdown of the identities of sellers. In some embodiments, the buyer knows the price he is purchasing the one or more goods, service, and/or rights but is blind to the identity of one or more the seller. In some embodiments, the buyer is blind to a breakdown of at least some of the pricing and/or the identity of at least some of the sellers. In some embodiments, the combined bid is below, equal to, or greater than the reserve price specified by the buyer. In a first non-limiting example, a buyer offers to purchase a television with a 3 year extended warranty for $1,000, and the intermediary application awards the sale of the television for $850 to one seller and an extended warranty for $50 to another seller. In a second non-limiting example, a buyer offers to purchase a vacation for $2,000; the intermediary application awards a $750 flight to one seller, a $500 hotel room to another seller, and a $550 car rental to yet another seller. In a third, non-limiting example, a buyer offers to purchase a vacation for $2,000, the vacation including a hotel stay in a hotel with at least four stars. The intermediary application awards a $750 flight to one seller, a $500 hotel room to another seller, and a $550 car rental to yet another seller. The buyer is informed that the flight is being sold by Delta Airlines and the rental car is being sold by Hertz, but the buyer is blind to the identity of the four star hotel until a later time. In some embodiments, the buyer is blind to the identity of the hotel because the seller and/or the intermediary application have placed holds on rooms in several different four star hotels at or near the destination of interest to the buyer. The seller and/or the intermediary application allocates the sale of the room in one hotel to the buyer based on the demand of hotel rooms in the different four star hotels in which holds have been placed. In various embodiments, the allocation is based on other buyer offers and/or maximizing profit for the seller and/or the intermediary application. In further or additional embodiments, the profit of the intermediary application comprises collecting a commission and/or a fee from one or more sellers.

### Distribution of Funds

In some embodiments, the platforms, systems, media, and methods described herein include a software module configured to distribute verified funds to complete the transaction, or use of the same. In various embodiments, a buyer's credit card is charged and the funds are provided to the seller when the seller wins the reverse auction. In further or additional embodiments, the credit card is charged the amount held on the buyer's credit card. In further or additional embodiments, the credit card is charged the price indicated by the winning bid of the reverse auction. In various embodiments, the buyer's checking and/or savings account is debited and the funds are provided to the seller when the seller wins the reverse auction. In various embodiments, the buyer's debit card is charged such that the buyer's checking and/or savings account is debited and the funds are provided to the seller when the seller wins the reverse auction. In various embodiments, the buyer's checking and/or savings account is debited the amount held by the ACH hold and the funds are provided to the seller when the seller wins the reverse auction. In various embodiments, the buyer's savings account is debited and the funds are provided to the seller when the seller wins the reverse auction. In further or additional embodiments, the buyer's checking and/or savings account is debited the price indicated by the winning bid of the reverse auction. In various embodiments, digital cash owned by the buyer is provided to the seller when the seller wins the reverse auction. In various embodiments, cryptocurrency owned by the buyer is provided to the seller when the seller wins the reverse auction. In various embodiments, cryptocurrency comprises Bitcoin, Namecoin, Litecoin, Peercoin, Ripple, Mastercoin, Primecoin, Dogecoin, Darkcoin, Auroracoin, or a combination thereof. In various embodiments, the seller is paid the amount held on the buyer's electronic payment account, for example PayPal, Google Wallet, 2Checkout, Shill, and Apple Pay. In further or additional embodiments, the buyer's electronic payment account is charged the price indicated by the winning bid of the reverse auction.

In some embodiments, the platforms, systems, media, and methods described herein include a software module configured to distribute verified funds to complete the transaction, or use of the same. In various embodiments, a seller is paid from the escrow account associated with the buyer, wherein funds advanced by the buyer to cover the purchase of a desired one or more goods, services, and/or rights are held by a third party pending fulfillment by a qualified seller. In further or additional embodiments, when a seller wins a binding purchase offer, the funds are debited from the escrow account and remitted to the seller automatically. In various embodiments, the escrow account is held by a third party and/or the host of the intermediary application configured to provide a reverse auction environment. In various embodiments, the escrow account is held by a third party and/or the host of the intermediary application. In further or additional embodiments, the third party is a bank and/or an escrow company.

In some embodiments, the platforms, systems, media, and methods described herein include a software module configured to distribute verified funds to complete the transaction, or use of the same. In various embodiments, when the buyer uses a plurality of payment methods to verify funds and one or more sellers win the reverse auction, one or more of the plurality of payment methods are used to pay the one or more sellers.

In some embodiments, the platforms, systems, media, and methods described herein include a software module configured to distribute verified funds to complete the transaction, or use of the same. In various embodiments, a buyer purchases one or more credits from an entity, and the credits are used to make a binding purchase to the intermediary application, therefore verifying the availability of buyer funds to pay the seller. In various embodiments, a buyer purchases one or more credits from an entity, and the credits are used to make a binding purchase to the intermediary application, wherein the binding purchase is for a portion of the purchase price, therefore verifying the availability of buyer funds to pay the seller the portion of the purchase price. In various embodiments, the credits purchased from an entity are used as a down payment for the purchase of one or more goods, services, and/or rights. In various embodiments, the credits are associated with a monetary value, for example about $1, about $2, about $3, about $4, about $5, about $10, about $20, about $50, about $100, about $500, about $1,000, about $5,000, about $10,000, about $50,000, about $100,000 or greater than about $100,000. In further or additional embodiments, currencies other than the dollar are used. In various embodiments, the entity is a third party, for example a private or public corporation and/or a bank. In various embodiments, the entity is the host of the intermediary application configured to provide a reverse auction. In various embodiments, when one or more sellers win the reverse auction, the seller is paid by the entity from which credits were purchased thereby guaranteeing payment from the buyer to the seller by entity.

In some embodiments, the platforms, systems, media, and methods described herein include a reverse auction environment, or use of the same. In various embodiments, when a binding purchase between a buyer and one or more sellers is effectuated, the buyer's verified funds are automatically transferred to the one or more sellers such that the buyer and/or the seller cannot modify the purchase. In various embodiments, when a binding purchase between a buyer and one or more sellers is effectuated, the buyer and/or the seller is able to modify the purchase such that the purchase price is increased or decreased. In further or additional embodiments, when the purchase price is increased the buyer authorizes additional funds be transferred to the seller. In further or additional embodiments, when the purchase price is decreased the seller authorizes a refund of the amount of price decrease to the buyer. In various embodiments, when a binding purchase between a buyer and one or more sellers is effectuated, the buyer and/or the seller is able to modify the purchase such that one or more additional goods, services, and/or rights are purchased. In further or additional embodiments, when the buyer purchases one or more additional goods, services, and/or rights, the buyer authorizes funds to be transferred to the seller for the purchase price of the one or more additional goods, services, and/or rights. In various embodiments, when a binding purchase between a buyer and one or more sellers is effectuated, the buyer and/or the seller agree to mutually nullify the purchase such that the purchase is no longer binding. In further or additional embodiments, when the buyer and/or the seller agree to mutually nullify the purchase, the funds are not transferred from the buyer to the seller and/or the funds are refunded to the buyer. In further or additional embodiments, when the buyer and/or the seller agree to mutually nullify the purchase, the one or more goods, services, and/or rights are returned to the seller and/or the one or more goods and/or rights are not sent by the seller. In further or additional embodiments, when the buyer and/or the seller agree to mutually nullify the purchase, the one or more services are not provided by the seller. In various embodiments, nullifying and/or modifying a binding purchase is governed by local law, municipal law, city law, state law, U.S.A. law, laws of a foreign jurisdiction, international law, or a combination thereof. In further or additional embodiments, a law is an ordinance and/or a rule.

### Reverse Auction Process

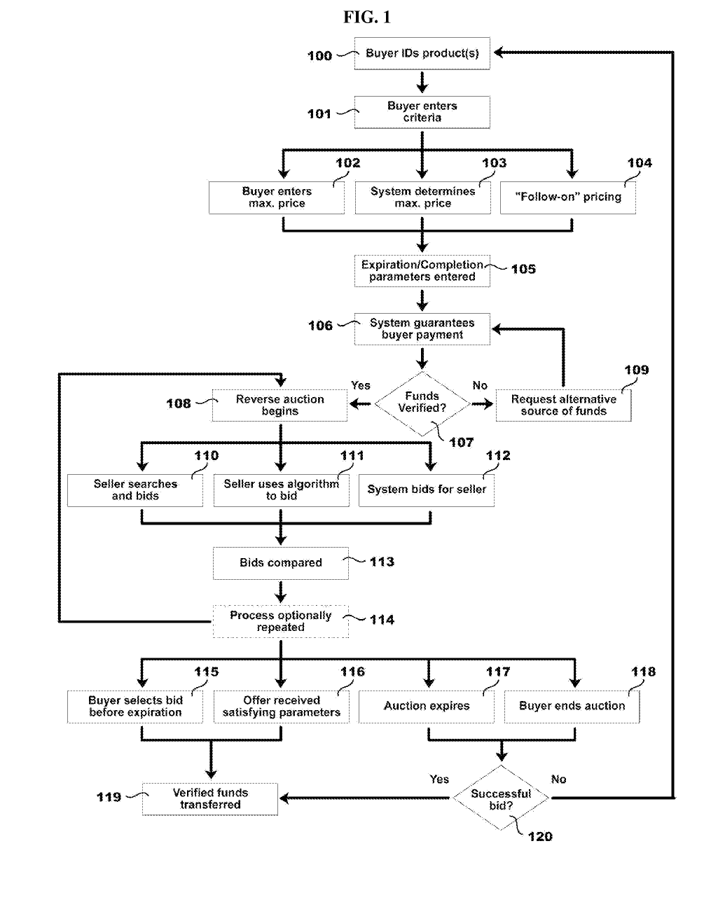

In some embodiments, the platforms, systems, media, and methods described herein comprise an intermediary application configured to provide a reverse auction environment, wherein sellers compete to obtain business from a buyer, disclosed herein are improvements comprising an assured demand allocation system with guaranteed buyer funds and automated dynamic item and price allocation. A non-limiting example of a reverse auction process of the platforms, systems, media, and methods described herein is depicted in FIG. 1. As depicted in the non-limiting example of FIG. 1, a buyer enters, selects, or searches for one or more goods, services, rights, or a combination thereof 100, for which the buyer intends to make an offer. In some embodiments, the buyer enters one or more additional criteria 101, for example quantitative data (e.g. lowest price, which, in some embodiments, incorporates secondary quantitative data such as shipping and handling costs) and/or qualitative data (e.g. seller reputation, ranking, rating, review score(s), number of previous sales, payment methods accepted, condition of previously delivered items, location, speed of delivery, shipping provider, local delivery availability, local pickup availability, and auxiliaries such as warranties and/or guarantees). After the buyer performs steps 101 and 102, (1) the buyer enters a maximum price 102 for which they will purchase the one or more goods, services, rights, or a combination thereof, (2) the intermediary application specifies a maximum price (i.e. a reserve price) 103 for which the buyer will purchase the one or more goods, services, rights, or a combination thereof, and/or (3) a “follow-on” pricing is specified 104, wherein one or more variables of a previous successful sale of the one or more goods, services, rights, or a combination thereof are provided such that the buyer can “follow-on” the sale. In some embodiments, the buyer selects the “follow-on” pricing. In some embodiments, the pricing and/or the one or more additional criteria makeup the offer for the one or more goods, services, rights, or a combination thereof. After steps 101, 102, and 103 are completed, expiration and/or completion parameters are entered, selected, or forced (e.g. a specified time such as 7 days or completion after receiving the first offer which satisfies price and additional criteria) 105. The intermediary application then guarantees buyer payment 106 using one or more embodiments of the assured demand allocation system detailed above. If funds are not verified, the intermediary application requests an alternative source of funds 109 and the intermediary application attempts to guarantee payment. If the funds are verified 107, the reverse auction begins 108. Once the reverse auction begins, (1) one or more sellers search for the offer proposed by the buyer and place a bid 110, (2) one or more sellers algorithmically locate and bid on the offer proposed by the buyer 111, and/or (3) the intermediary application bids on behalf of one or more sellers 112. Entered bids are then compared 113, and, if the reverse auction is not ended, the reverse auction is repeated 114. The reverse auction is ended when (1) the buyer accepts a bid before the reverse auction expiration and/or completion parameters expire 115, which optionally include limited-time bids, (2) the criteria specified by the buyer are met 116, (3) the reverse auction expiration and/or completion parameters expire 117, or (4) the buyer chooses to terminate the auction 118. If the criteria specified by the buyer are met, the verified funds are transferred 119 to the one or more sellers. If the reverse auction time expires or the buyer chooses to terminate the auction, the intermediary application checks whether a successful bid was made 120. If a successful bid was made, the verified funds are transferred to the one or more sellers. In some embodiments, if a successful bid was not made, the reverse auction restarts automatically. In some embodiments, a buyer chooses to restart the auction automatically if a successful bid is not made. In various embodiments, a buyer selects a number of times the reverse auction will be automatically restarted if a successful bid is not made. In further or additional embodiments, after the reverse auction is restarted the specified number of times, if a successful bid is not made, the reverse auction is not restarted. In some embodiments, if a successful bid was not made, the buyer chooses whether to restart the reverse auction. In some embodiments, when entire process is repeated, the buyer recommends different criteria, for example a different price and/or one or more different additional criteria. In some embodiments, rather than transferring verified funds, the guaranteed funds that were already collected, for example using an escrow account, become non-refundable to the buyer.

### Price Comparison Alternate Offer

In some embodiments, the platforms, systems, media, and methods described herein include a software module configured to provide a price comparison alternate offer, or use of the same. In some embodiments, the price comparison alternate offer is provided to a buyer when the buyer is selecting a price to offer for one or more goods, services, rights, or combination thereof. In various embodiments, the buyer selects the price they are willing to pay for the one or more goods, services, rights, or a combination thereof. In various embodiments, the buyer selects the price when the buyer is preparing to start a reverse auction. In various embodiments, the buyer is selecting the price for a reason other than to start a reverse auction.

In some embodiments, the platforms, systems, media, and methods described herein include a software module configured to provide a price comparison alternate offer, or use of the same. In various embodiments, the alternate offer comprises different brands, makes, and/or models of the one or more goods the buyer seeks to purchase thus satisfying the buyer's request by mixing brands, makes, and/or models of the one or more goods. In further or additional embodiments, mixing brands, makes, and/or models allows the price of the one or more goods to be equal to or less than the price offered by the buyer. In various embodiments, the alternate offer comprises one or more services the buyer seeks to purchase, wherein the one or more services are provided by one or more sellers similar to one or more sellers specified by the buyer. In further or additional embodiments, using one or more sellers similar to the one or more seller specified by the buyer allows the price of the one or more services to be equal to or less than the price offered by the buyer. In various embodiments, the alternate offer comprises one or more rights that are similar to the one or more rights the buyer seeks to purchase. In further or additional embodiments, offering one or more rights that are similar to the one or more rights the buyer seeks to purchase allows the price of the one or more rights to be equal to or less than the price offered by the buyer. As a non-limiting example, a buyer wants to purchase 10 boxes of tissue paper for $10 and does not specify a particular brand of tissue. The software module autonomously allocates 8 boxes of Kleenex and 2 boxes of Puffs for $9.

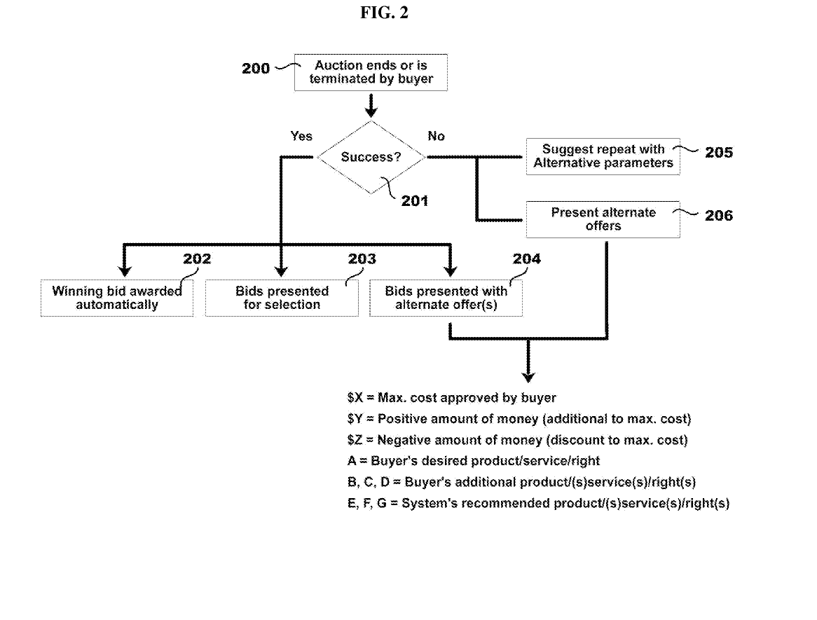

A non-limiting example of using the software module configured to provide a price comparison alternate offer after a reverse auction ends or is terminated is depicted in FIG. 2. As depicted in the non-limiting example of FIG. 2, an auction ends or is terminated by the buyer 200. After the auction ends or is terminated by the buyer, the software module checks whether the auction was a success 201. If the auction was successful, (1) the winning bid is awarded automatically 202, (2) a plurality of bids that meet seller criteria are presented to the buyer for selection 203, or (3) one or more bids are presented with alternate offers 204. Alternate offers are calculated using one or more variables comprising: (a) a maximum cost approved by the buyer ($X); (b) a positive amount of money (i.e. additional to maximum cost) ($Y); (c) a negative amount of money (i.e. discount to maximum cost) ($Z); (d) the buyer's desired good, service, or right (A); (e) the buyer's additional desired good, service, or right (B, C, and/or D); and (f) a recommended good, service, and/or right (E, F, and/or G). If the buyer desires a single good, service, or right, alternative offers are provided according to the following non-limiting examples:
If A not ≦$X
then present alternate offer(s):
A=$X+$Y
A+E=$X+$Y
A+F=$X+$Y
A+G=$X+$Y
E+F=$X+$Y
E+G=$X+$Y
F+G=$X+$Y
A+E+F=$X+$Y
A+E+G=$X+$Y
E+F+G=$X+$Y
A+E+ . . . =$X+$Y
A+F+ . . . =$X+$Y
A+G+ . . . =$X+$Y
E+F+ . . . =$X+$Y
E+G+ . . . =$X+$Y
F+G+ . . . =$X+$Y
A+E+F+ . . . =$X+$Y
A+E+G+ . . . =$X+$Y
A+F+G+ . . . =$X+$Y
E+F+G+ . . . =$X+$Y
E=$X−$Z
F=$X−$Z
G=$X−$Z
A+E=$X−$Z
A+F=$X−$Z
A+G=$X−$Z
E+F=$X−$Z
E+G=$X−$Z
F+G=$X−$Z
A+E+F=$X−$Z
A+E+G=$X−$Z
E+F+G=$X−$Z
A+E+ . . . =$X−$Z
A+F+ . . . =$X−$Z
A+G+ . . . =$X−$Z
E+F+ . . . =$X−$Z
E+G+ . . . =$X−$Z
F+G+ . . . =$X−$Z
A+E+F+ . . . =$X−$Z
A+E+G+ . . . =$X−$Z
A+F+G+ . . . =$X−$Z
E+F+G+ . . . =$X−$Z
E≦$X
F≦$X
G≦$X
A+E≦$X
A+F≦$X
A+G≦$X
E+F≦$X
E+G≦$X
F+G≦$X
A+E+F≦$X
A+E+G≦$X
E+F+G≦$X
A+E+ . . . ≦$X
A+F+ . . . ≦$X
A+G+ . . . ≦$X
E+F+ . . . ≦$X
E+G+ . . . ≦$X
F+G+ . . . ≦$X
A+E+F+ . . . ≦$X
A+E+G+ . . . ≦$X
A+F+G+ . . . ≦$X
E+F+G+ . . . ≦$X

If the buyer desires two goods, services, rights, or a combination thereof alternative offers are provided according to the following non-limiting examples:
If A+B not ≦$X
then present alternate offer(s):
A=$X+$Y
B=$X+$Y
E=$X+$Y
F=$X+$Y
G=$X+$Y
A+B=$X+$Y
A+E=$X+$Y
A+F=$X+$Y
A+G=$X+$Y
B+E=$X+$Y
B+F=$X+$Y
B+G=$X+$Y
E+F=$X+$Y
E+G=$X+$Y
F+G=$X+$Y
A+B+E=$X+$Y
A+B+F=$X+$Y
A+B+G=$X+$Y
A+E+F=$X+$Y
A+E+G=$X+$Y
A+F+G=$X+$Y
B+E+F=$X+$Y
B+E+G=$X+$Y
B+F+G=$X+$Y
E+F+G=$X+$Y
A+ . . . =$X+$Y
B+ . . . =$X+$Y
E+ . . . =$X+$Y
F+ . . . =$X+$Y
G+ . . . =$X+$Y
A+B+ . . . =$X+$Y
A+E+ . . . =$X+$Y
A+F+ . . . =$X+$Y
A+G+ . . . =$X+$Y
B+E+ . . . =$X+$Y
B+F+ . . . =$X+$Y
B+G+ . . . =$X+$Y
E+F+ . . . =$X+$Y
E+G+ . . . =$X+$Y
F+G+ . . . =$X+$Y
A+B+E+ . . . =$X+$Y
A+B+F+ . . . =$X+$Y
A+B+G+ . . . =$X+$Y
A+E+F+ . . . =$X+$Y
A+E+G+ . . . =$X+$Y
A+F+G+ . . . =$X+$Y
B+E+F+ . . . =$X+$Y
B+E+G+ . . . =$X+$Y
B+F+G+ . . . =$X+$Y
E+F+G+ . . . =$X+$Y
A=$X−$Z
B=$X−$Z
E=$X−$Z
F=$X−$Z
G=$X−$Z
A+B=$X−$Z
A+E=$X−$Z
A+F=$X−$Z
A+G=$X−$Z
B+E=$X−$Z
B+F=$X−$Z
B+G=$X−$Z
E+F=$X−$Z
E+G=$X−$Z
F+G=$X−$Z
A+B+E=$X−$Z
A+B+F=$X−$Z
A+B+G=$X−$Z
A+E+F=$X−$Z
A+E+G=$X−$Z
A+F+G=$X−$Z
B+E+F=$X−$Z
B+E+G=$X−$Z
B+F+G=$X−$Z
E+F+G=$X−$Z
A+ . . . =$X−$Z
B+ . . . =$X−$Z
E+ . . . =$X−$Z
F+ . . . =$X−$Z
G+ . . . =$X−$Z
A+B+ . . . =$X−$Z
A+E+ . . . =$X−$Z
A+F+ . . . =$X−$Z
A+G+ . . . =$X−$Z
B+E+ . . . =$X−$Z
B+F+ . . . =$X−$Z
B+G+ . . . =$X−$Z
E+F+ . . . =$X−$Z
E+G+ . . . =$X−$Z
F+G+ . . . =$X−$Z
A+B+E+ . . . =$X−$Z
A+B+F+ . . . =$X−$Z
A+B+G+ . . . =$X−$Z
A+E+F+ . . . =$X−$Z
A+E+G+ . . . =$X−$Z
A+F+G+ . . . =$X−$Z
B+E+F+ . . . =$X−$Z
B+E+G+ . . . =$X−$Z
B+F+G+ . . . =$X−$Z
E+F+G+ . . . =$X−$Z
A≦$X
B≦$X
E≦$X
F≦$X
G≦$X
A+B≦$X
A+E≦$X
A+F≦$X
A+G≦$X
B+E≦$X
B+F≦$X
B+G≦$X
E+F≦$X
E+G≦$X
F+G≦$X
A+B+E≦$X
A+B+F≦$X
A+B+G≦$X
A+E+F≦$X
A+E+G≦$X
A+F+G≦$X
B+E+F≦$X
B+E+G≦$X
B+F+G≦$X
E+F+G≦$X
A+ . . . ≦$X
B+ . . . ≦$X
E+ . . . ≦$X
F+ . . . ≦$X
G+ . . . ≦$X
A+B+ . . . ≦$X
A+E+ . . . ≦$X
A+F+ . . . ≦$X
A+G+ . . . ≦$X
B+E+ . . . ≦$X
B+F+ . . . ≦$X
B+G+ . . . ≦$X
E+F+ . . . ≦$X
E+G+ . . . ≦$X
F+G+ . . . ≦$X
A+B+E+ . . . ≦$X
A+B+F+ . . . ≦$X
A+B+G+ . . . ≦$X
A+E+F+ . . . ≦$X
A+E+G+ . . . ≦$X
A+F+G+ . . . ≦$X
B+E+F+ . . . ≦$X
B+E+G+ . . . ≦$X
B+F+G+ . . . ≦$X
E+F+G+ . . . ≦$X

If the buyer desires three or more goods, services, rights, or a combination thereof alternative offers are provided according to the following non-limiting examples:
If A+B+C+ . . . not ≦$X
then present alternate offer(s):
A=$X+$Y
B=$X+$Y
C=$X+$Y
E=$X+$Y
F=$X+$Y
G=$X+$Y
A+B=$X+$Y
A+C=$X+$Y
A+E=$X+$Y
A+F=$X+$Y
A+G=$X+$Y
B+C=$X+$Y
B+E=$X+$Y
B+F=$X+$Y
B+G=$X+$Y
C+E=$X+$Y
C+F=$X+$Y
C+G=$X+$Y
E+F=$X+$Y
E+G=$X+$Y
F+G=$X+$Y
A+B+E=$X+$Y
A+B+F=$X+$Y
A+B+G=$X+$Y
A+C+E=$X+$Y
A+C+F=$X+$Y
A+C+G=$X+$Y
A+E+F=$X+$Y
A+E+G=$X+$Y
A+F+G=$X+$Y
B+E+F=$X+$Y
B+E+G=$X+$Y
B+F+G=$X+$Y
B+C+E=$X+$Y
B+C+F=$X+$Y
B+C+G=$X+$Y
C+E+F=$X+$Y
C+E+G=$X+$Y
C+F+G=$X+$Y
E+F+G=$X+$Y
A+ . . . =$X+$Y
B+ . . . =$X+$Y
C+ . . . =$X+$Y
E+ . . . =$X+$Y
F+ . . . =$X+$Y
G+ . . . =$X+$Y
A+B+ . . . =$X+$Y
A+C+ . . . =$X+$Y
A+E+ . . . =$X+$Y
A+F+ . . . =$X+$Y
A+G+ . . . =$X+$Y
B+C+ . . . =$X+$Y
B+E+ . . . =$X+$Y
B+F+ . . . =$X+$Y
B+G+ . . . =$X+$Y
C+E+ . . . =$X+$Y
C+F+ . . . =$X+$Y
C+G+ . . . =$X+$Y
E+F+ . . . =$X+$Y
E+G+ . . . =$X+$Y
F+G+ . . . =$X+$Y
A+B+E+ . . . =$X+$Y
A+B+F+ . . . =$X+$Y
A+B+G+ . . . =$X+$Y
A+C+E+ . . . =$X+$Y
A+C+F+ . . . =$X+$Y
A+C+G+ . . . =$X+$Y
A+E+F+ . . . =$X+$Y
A+E+G+ . . . =$X+$Y
A+F+G+ . . . =$X+$Y
B+E+F+ . . . =$X+$Y
B+E+G+ . . . =$X+$Y
B+F+G+ . . . =$X+$Y
B+C+E+ . . . =$X+$Y
B+C+F+ . . . =$X+$Y
B+C+G+ . . . =$X+$Y
C+E+F+ . . . =$X+$Y
C+E+G+ . . . =$X+$Y
C+F+G+ . . . =$X+$Y
E+F+G+ . . . =$X+$Y
A=$X−$Z
B=$X−$Z
C=$X−$Z
E=$X−$Z
F=$X−$Z
G=$X−$Z
A+B=$X−$Z
A+C=$X−$Z
A+E=$X−$Z
A+F=$X−$Z
A+G=$X−$Z
B+C=$X−$Z
B+E=$X−$Z
B+F=$X−$Z
B+G=$X−$Z
C+E=$X−$Z
C+F=$X−$Z
C+G=$X−$Z
E+F=$X−$Z
E+G=$X−$Z
F+G=$X−$Z
A+B+E=$X−$Z
A+B+F=$X−$Z
A+B+G=$X−$Z
A+C+E=$X−$Z
A+C+F=$X−$Z
A+C+G=$X−$Z
A+E+F=$X−$Z
A+E+G=$X−$Z
A+F+G=$X−$Z
B+E+F=$X−$Z
B+E+G=$X−$Z
B+F+G=$X−$Z
B+C+E=$X−$Z
B+C+F=$X−$Z
B+C+G=$X−$Z
C+E+F=$X−$Z
C+E+G=$X−$Z
C+F+G=$X−$Z
E+F+G=$X−$Z
A+ . . . =$X−$Z
B+ . . . =$X−$Z
C+ . . . =$X−$Z
E+ . . . =$X−$Z
F+ . . . =$X−$Z
G+ . . . =$X−$Z
A+B+ . . . =$X−$Z
A+C+ . . . =$X−$Z
A+E+ . . . =$X−$Z
A+F+ . . . =$X−$Z
A+G+ . . . =$X−$Z
B+C+ . . . =$X−$Z
B+E+ . . . =$X−$Z
B+F+ . . . =$X−$Z
B+G+ . . . =$X−$Z
C+E+ . . . =$X−$Z
C+F+ . . . =$X−$Z
C+G+ . . . =$X−$Z
E+F+ . . . =$X−$Z
E+G+ . . . =$X−$Z
F+G+ . . . =$X−$Z
A+B+E+ . . . =$X−$Z
A+B+F+ . . . =$X−$Z
A+B+G+ . . . =$X−$Z
A+C+E+ . . . =$X−$Z
A+C+F+ . . . =$X−$Z
A+C+G+ . . . =$X−$Z
A+E+F+ . . . =$X−$Z
A+E+G+ . . . =$X−$Z
A+F+G+ . . . =$X−$Z
B+E+F+ . . . =$X−$Z
B+E+G+ . . . =$X−$Z
B+F+G+ . . . =$X−$Z
B+C+E+ . . . =$X−$Z
B+C+F+ . . . =$X−$Z
B+C+G+ . . . =$X−$Z
C+E+F+ . . . =$X−$Z
C+E+G+ . . . =$X−$Z
C+F+G+ . . . =$X−$Z
E+F+G+ . . . =$X−$Z
A≦$X
B≦$X
C≦$X
E≦$X
F≦$X
G≦$X
A+B≦$X
A+C≦$X
A+E≦$X
A+F≦$X
A+G≦$X
B+C≦$X
B+E≦$X
B+F≦$X
B+G≦$X
C+E≦$X
C+F≦$X
C+G≦$X
E+F≦$X
E+G≦$X
F+G≦$X
A+B+E≦$X
A+B+F≦$X
A+B+G≦$X
A+C+E≦$X
A+C+F≦$X
A+C+G≦$X
A+E+F≦$X
A+E+G≦$X
A+F+G≦$X
B+E+F≦$X
B+E+G≦$X
B+F+G≦$X
B+C+E≦$X
B+C+F≦$X
B+C+G≦$X
C+E+F≦$X
C+E+G≦$X
C+F+G≦$X
E+F+G≦$X
A+ . . . ≦$X
B+ . . . ≦$X
C+ . . . ≦$X
E+ . . . ≦$X
F+ . . . ≦$X
G+ . . . ≦$X
A+B+ . . . ≦$X
A+C+ . . . ≦$X
A+E+ . . . ≦$X
A+F+ . . . ≦$X
A+G+ . . . ≦$X
B+C+ . . . ≦$X
B+E+ . . . ≦$X
B+F+ . . . ≦$X
B+G+ . . . ≦$X
C+E+ . . . ≦$X
C+F+ . . . ≦$X
C+G+ . . . ≦$X
E+F+ . . . ≦$X
E+G+ . . . ≦$X
F+G+ . . . ≦$X
A+B+E+ . . . ≦$X
A+B+F+ . . . ≦$X
A+B+G+ . . . ≦$X
A+C+E+ . . . ≦$X
A+C+F+ . . . ≦$X
A+C+G+ . . . ≦$X
A+E+F+ . . . ≦$X
A+E+G+ . . . ≦$X
A+F+G+ . . . ≦$X
B+E+F+ . . . ≦$X
B+E+G+ . . . ≦$X
B+F+G+ . . . ≦$X
B+C+E+ . . . ≦$X
B+C+F+ . . . ≦$X
B+C+G+ . . . ≦$X
C+E+F+ . . . ≦$X
C+E+G+ . . . ≦$X
C+F+G+ . . . ≦$X
E+F+G+ . . . ≦$X
   It is noted that in the equations above, in some embodiments, $Z>0. In some embodiments, it is not economically feasible to fulfill an order for a desired price. However, in some embodiments, using the software module configured to provide a price comparison alternate offer to change one or more variables, it is possible to satisfy the desired price. In some embodiments, when presenting alternate offers for more than one good, service, right, or a combination thereof, itemized pricing is disclosed to the buyer. In some embodiments, when presenting alternate offers for more than one good, service, right, or a combination thereof, itemized pricing is not disclosed to the buyer. In various embodiments, itemized pricing is not shown because showing itemized pricing has drawbacks, for example the buyer finds the “weak link” in their offer and/or profit margins are revealed.

### Digital Processing Device

In some embodiments, the platforms, systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, vehicles, and wearable computing devices. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art. Those of skill in the art will recognize wearable computing devices suitable to work with the platforms, systems, media, and methods described herein comprise a smart watch, smart glasses (e.g. Google Glass®, Microsoft HoloLens®), clothing comprising computing devices, and any other computing device that can be attached to or worn by a person and/or animal.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In various embodiments, the input device is a device capable of recognizing one or more physical gestures and/or motions. In further embodiments, the input device is a Microsoft Kinect®, Leap Motion®, or the like. In still further embodiments, the input device is a combination of devices such as those disclosed herein.

### Server Configuration

In some embodiments, a suitable server configuration includes about 1, about 2, about 3, about 4, about 5, about 6, about 7, about 8, about 9, about 10, about 20, about 30, about 40, about 50, about 60, about 70, about 80, about 90, about 100, about 200, about 500, about 1000, more than about 1000 servers, one or more server farms, and cloud-based server resource allocation systems. In some embodiments, the servers are co-located. In some embodiments, the servers are located in different geographical locations. In some embodiments the servers are housed in the same rack. In some embodiments, the servers are housed in multiple racks. In some embodiments, the multiple racks are in the same geographic region. In some embodiments the racks are in different geographic regions. In some embodiments, the server is or a plurality of servers employ a software framework such as Hadoop, Google MapReduce, HBase, and/or Hive, for storage and large-scale processing of data-sets on clusters of hardware.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of item, buyer, and seller information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1

### Offer and/or Bid Pricing Guidance

In this non-limiting example, a buyer intends to purchase a television with a MSRP of $1,000 and a smartphone with a MSRP of $600 using the platforms, systems, media, and methods described herein.

Using a graphical interface provided by the platforms, systems, media, and methods described herein, the buyer initiates a 7 day reverse auction to purchase the television and the smartphone for a total price of no more than $1400 (i.e. a reserve price of $1400). Also, using a graphical interface provided by the platforms, systems, media, and methods described herein, the buyer inputs their credit card number in order to verify at least $1400 is available to purchase the television and the smartphone. The platforms, systems, media, and methods described herein place a hold for $1400 on the buyer's credit card.

The platforms, systems, media, and methods described herein send a notification (i.e. an email, phone call, and/or a text message) to a plurality of qualified sellers, the identity of which are stored in a database. The plurality of qualified sellers use a graphical interface provided by the platforms, systems, media, and methods described herein to view the reverse auction. Using a graphical interface provided by the platforms, systems, media, and methods described herein each of the plurality of seller place a bid for the sale of the television and/or the smartphone, each bid comprising a sale price. A first seller bids a sale price of $800 for the television, a second seller bids a sale price of $450 for the smartphone, and a third seller bids a price of $1350 for both the television and the smartphone.

At the end of the 7 day time period the reverse auction ends and the platforms, systems, media, and methods described herein select the first and second sellers as winners of the reverse auction. The platforms, systems, media, and methods described herein charges the buyer's credit card $1250 and distributes $800 to the first seller and $450 to the second seller. The first seller ships the television to the buyer, and the second seller ships the smartphone to the buyer.

### Example 2

### Offer and/or Bid Pricing Guidance

In this non-limiting example, a buyer intends to purchase a television with a MSRP of $1,000 using the platforms, systems, media, and methods described herein. The platforms, systems, media, and methods described herein are configured to provide guidance for the buyer of the television. In this example, the guidance indicates that the average profit margin for the market sector that sells televisions is 8%. Further, based on historical data collected by the platforms, systems, media, and methods described herein, the guidance indicates 97% of sales occur with a winning selling bid between $980 and $999, 54% of sales occur with a winning selling bid between $960 and $979, 19% of sales occur with a winning selling bid between $940 and $959, 8% of sales occur with a winning selling bid between $920 and $939, 3% of sales occur with a winning selling bid between $900 and $919, and 0% of sales occur with a price below $900. This information is presented in a plurality of ways including simple text, charts, scales, and other graphical interfaces.

Based on this information, the buyer will select an offer price that balances the buyer's desire to purchase the television with the buyer's risk that the reverse auction will not be successful. If the buyer significantly desires to purchase the television, the buyer will offer a higher price. Conversely, if the buyer less significantly desires to purchase the television and/or wants to receive a great deal (i.e. discount price based on MSRP), the buyer will offer a lower price.

### Example 3

### Limited Time Bidding

In this non-limiting example, a buyer intends to purchase a television using the platforms, systems, media, and methods described herein. The buyer initiates a 10 day reverse auction to purchase the television for an offer price of $900. The buyer specifies the make and model of the television. After initiating the reverse auction, a plurality of sellers submit bids, some of which are below the buyer's offer price. Further, a first seller submits a bid of $890 and submits a limited time bid of $850 if the buyer chooses them within the next 60 minutes. The limited time bid convinces the buyer to accept the bid within the next 60 minutes and end the auction before the end of the 10 day time period.

In another embodiment of this non-limiting example, a buyer intends to purchase a television using the platforms, systems, media, and methods described herein. The buyer initiates a 10 day reverse auction to purchase the television for an offer price of $900. The buyer does not specify the make and model of the television, but the buyer specifies one or more characteristics of the television, for example, the resolution, size. After initiating the reverse auction, a plurality of sellers submit bids, some of which are below the buyer's offer price. Further, a first seller submits a bid of $890 and submits a limited time bid of $850 if the buyer chooses them within the next 60 minutes. The limited time bid convinces the buyer to accept the bid within the next 60 minutes and end the auction before the end of the 10 day time period.

In another embodiment of this non-limiting example, a buyer intends to purchase a television using the platforms, systems, media, and methods described herein. The buyer initiates a 10 day reverse auction to purchase the television for an offer price of $900. The buyer specifies one or more brands as well as one or characteristics of the television, for example, the resolution, size. After initiating the reverse auction, a plurality of sellers submit bids, some of which are below the buyer's offer price. Further, a first seller submits a bid of $890 and submits a limited time bid of $850 if the buyer chooses them within the next 60 minutes. The limited time bid convinces the buyer to accept the bid within the next 60 minutes and end the auction before the end of the 10 day time period.

### Example 4

### Seller Bidding System in a Reverse Auction

In this non-limiting example, a buyer intends to purchase a television with 3 year extended warranty for $1,000 using the platforms, systems, media, and methods described herein. The buyer initiates a reverse auction to purchase the television. In order to satisfy the buyer's offer, the platforms, systems, media, and methods described herein dynamically allocate sale of each item to one or more sellers based on one or more sellers' bids. A first seller is awarded the sale of the television for $900, and a second seller is awarded the sale of the extended warranty for $50.

In another embodiment of this non-limiting example, a buyer intends to purchase a vacation package for $2,000 using the platforms, systems, media, and methods described herein configured to provide a reverse auction. The buyer initiates a reverse auction to purchase the vacation. In order to satisfy the buyer's offer, the platforms, systems, media, and methods described herein dynamically allocate sale of each item to one or more sellers based on one or more sellers' bids. A first seller is awarded the sale of a flight for $750, a second seller is awarded the sale of a hotel room for $500, and a third seller is awarded the sale of a vehicle rental for $600.

### Example 5

### Price Comparison Alternate Offer

In this non-limiting example, a buyer intends to order the following health supplements online:

a) Source of Life Adult's Chewable Multivitamin Apple-Cinnamon (normally $28.80)

b) Jarrow Formulas, Inc. R-Alpha Lipoic Acid with Biotin (normally $29.95)

c) Jarrow Formulas, Inc. CoQ10 200 mg (normally $29.95)

d) Doctor's Best Astaxanthin 6 mg (normally $49.99)

e) NOW Foods L-Carnosine 500 mg (normally $29.99)

The going retail price for the above is $168.68, but the buyer offers to pay no more than $110.

In this non-limiting example, the platforms, systems, media, and methods described herein determines it is not possible to fulfill the offer for $110. This is determined, for example, by going through a reverse auction process, and/or more comparing desired products to a pricing database. Because the host of the platforms, systems, media, and methods described herein does not want to lose the potential sale, the software module configured to provide an alternate offer determines other pricing models that will possibly work and presents them to the buyer. For example:
a) Offer A: $117 for exact specified products ($110 offer price+$7 additional)
b) Offer B: $110 for 4 of the 5 exact specified products and 1 product has been substituted with similar:
   (1) Source of Life Adult's Chewable Multivitamin Apple-Cinnamon
   (2) Jarrow Formulas, Inc. R-Alpha Lipoic Acid with Biotin
   (3) Substitute Jarrow Formulas, Inc. CoQ10 200 mg with Doctor's Best CoQ10 200 mg
   (4) Doctor's Best Astaxanthin 6 mg
   (5) NOW Foods L-Carnosine 500 mg
c) Offer C: $110 for 4 of the 5 exact specified products and 1 product has been substituted with similar:
   (1) Source of Life Adult's Chewable Multivitamin Apple-Cinnamon
   (2) Jarrow Formulas, Inc. R-Alpha Lipoic Acid with Biotin
   (3) Jarrow Formulas, Inc. CoQ10 200 mg
   (4) Substitute Doctor's Best Astaxanthin 6 mg with Nutrex Hawaii BioAstin Astaxanthin 6 mg
   (5) NOW Foods L-Carnosine 500
d) Offer D: $89 for 4 of the 5 exact specified products. 1 product has been eliminated.
   (1) Source of Life Adult's Chewable Multivitamin Apple-Cinnamon
   (2) Jarrow Formulas, Inc. R-Alpha Lipoic Acid with Biotin
   (3) Jarrow Formulas, Inc. CoQ10 200 mg
   (4) Doctor's Best Astaxanthin 6 mg

Any combination of the alternate offers are presented. For example in one scenario, all of the presented offers will equal the $110 price offer (those offers above and below are not presented). In another scenario, the system offers the 5 exact items for the desired $110 price point, but only if the buyer also buys one or more additional items at a presented price (e.g. bottle of vitamin C for $14, which would mean the total price would be $124). In another scenario, the system only honors the $110 price if the buyer buys double the quantity (e.g. 2 bottles of each product for a total of $220).

### Example 6

### Buyer Purchasing Groceries

In this non-limiting example, using the platforms, systems, media, and methods described herein, a buyer intends to purchase 10 grocery items, for example, apples, oranges, kale, carrots, milk, eggs, water, fish, beef, and pork. When shopping for these items using a particular grocer's pricing, in this example Whole Foods, the cost of the items is $60. The buyer then offers a total price of $50 to purchase the groceries and initiates a reverse auction to purchase the groceries. Once the reverse auction is initiated, a plurality of grocery stores are alerted. In response to the offer to buy, a Whole Foods store offers to sell the groceries for $54 and a Trader Joe's store offers to sell the groceries for $52. In response to the offer from the Trader Joe's store, the Whole Foods store offers to sell the groceries for $49. The buyer accepts the sale from the Whole Foods store for $49 and the reverse auction ends.

### Example 7

### Buyer Purchasing Groceries from Multiple Grocers

In this non-limiting example, using the platforms, systems, media, and methods described herein, a buyer intends to purchase 10 grocery items, for example, apples, oranges, kale, carrots, milk, eggs, water, fish, beef, and pork for a total price of $50. The buyer initiates a reverse auction to purchase the groceries. Once the reverse auction is initiated, a plurality of grocers and/or food providers is alerted of the reverse auction. For example Whole Foods, Trader Joes, Ralph's Vons, and local farms are alerted. In order to satisfy the buyer's offer, the platforms, systems, media, and methods described herein dynamically allocate sale of each item to one or more sellers based on one or more sellers' bids. A first seller is a farmer and is awarded the sale of the fruits and vegetables for $15. A second seller, Whole Foods, bids for the sale of the meat for $18. A third seller, Vons, is awarded the sale of the dairy product for $8.

### Example 8

### Reverse Auction without Start Price

In a first non-limiting example, a buyer initiates a reverse auction to find a person and/or company to paint his house. The buyer does not know the cost but offers verified funds of $500. By doing so, the buyer is committed to a sale so long as at least one seller bids $500 or less. Here, all sellers bid above $500 and buyer has the option to choose one of the sellers or walk away (i.e. is not obligated because all bids were above his reserve/offer price of $500).

In a second non-limiting example, a buyer initiates a reverse auction to find a person and/or company to paint his house. The buyer does not know the cost. The buyer offers verified finds of $250 and sets a reserve price of $1,000. Therefore, as long as there is one or more qualified bids of $1,000 or less, the buyer is committed to the sale, even though the buyer only verified a portion of the purchase price. Here, a seller bids $900 and the buyer is obligated to pay $900 for the service because $900 is less than the buyer's reserve price.

### Example 9

### Reverse Auction to Purchase Service and/or Goods at a Restaurant

In this non-limiting example, a buyer initiates a reverse auction to purchase a meal at a restaurant with the following limitations:
Date: Valentine's Day (February 14^{th})
Reservation time: anytime between 6:00 and 8:30 pm
Party size: 2 people
Location: within 20 mile radius of zip code 90266
Price rating: at least $$$ out of $$$$$
Urbanspoon rating: 85% or greater liked it
Cuisine: one or more of Italian, seafood, steakhouse, Mediterranean
Items offered for purchase (per person): drink, appetizer, entree, dessert
Reserve/Offer price: $150

The intermediary application confirms the buyer has $150 to pay the seller and begins the reverse auction. A first restaurant serving Italian cuisine with an Urbanspoon rating of 88% offers to sell the requested meal with the limitations indicated by the buyer for $140. A second restaurant offering Mediterranean cuisine with an Urbanspoon rating of 92% offers to sell the meal with the limitations indicated by the buyer for $170 because in addition to the limitations indicated by the buyer, the second restaurant offers an additional item of the reservation being at the special and private seating area at the restaurant. A third restaurant offering steakhouse cuisine with an Urbanspoon rating of 92% offers to sell the meal with the limitations indicated by the buyer for $175 because in additional to the limitations indicated by the buyer, the third restaurant offers an additional item of private transportation service to and from the restaurant. Even though the price is higher than the set reserve/offer price, the buyer selects to purchase from the second restaurant as he is enticed to purchase additional item (i.e. reservation at the special and private seating area at the restaurant). The intermediary application confirms the buyer has $170 to pay the seller and effectuates the purchase.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-implemented reverse auction system having a reverse auction environment wherein sellers compete to obtain business from a buyer, the improvement comprising an assured demand allocation system with guaranteed buyer funds and automated dynamic item and price allocation comprising:
a) a database, in a computer memory, of a plurality of sellers;
b) a software module configured to: receive an offer to buy from a buyer, the offer to buy directed to a plurality of items, each item having a price, the plurality of items comprising at least two non-identical items, the offer to buy having a total price; receive a proposed purchase price for the plurality of items from the buyer, the proposed purchase price being equal to or less than the total price; and calculate a respective share of the proposed purchase price for each item;
c) a software module configured to verify availability of funds from the buyer in the amount of at least a portion of the proposed purchase price before or concurrent with receiving bids from one or more of the plurality of sellers;
d) a software module configured to receive bids from the plurality of sellers, the bids for sale of one or more of the plurality of items, each bid having a price for the one or more of the plurality of items in the bid;
e) a software module configured to select one or more bidding sellers upon the expiration of a time period, each selected seller bidding on one or more of the plurality of items at a price equal to or less than the share of the proposed purchase price for the items in the bid;
f) a dynamic item and price allocation module configured to allocate sale of each of the plurality of items to one or more of the selected sellers, wherein each item in the plurality of items is allocated at an allocated price, wherein the aggregate allocated price for the plurality of items is equal to or less than the proposed purchase price, the one or more sellers receiving the allocation based on one or more seller characteristics selected from the group consisting of: price, shipping speed, shipping provider, local delivery availability, local pickup availability, seller rating, seller ranking, number of previous sales, warranty, payment methods accepted, and condition of previously delivered items, the allocation immediately making the sale binding, wherein the allocation of sale of each of the plurality of items occurs after verifying availability of funds from the buyer or after receiving bids from the plurality of sellers; and
g) a software module configured to distribute the verified funds to the one or more sellers, wherein the distribution of the verified funds occurs after verifying availability of funds from the buyer or after receiving bids from the plurality of sellers.

2. The system of claim 1, wherein the items comprise goods, services, rights, or a combination thereof.

3. The system of claim 1, wherein the price for each item in the offer to buy is one or more of a manufacturer's suggested retail price and a list price.

4. The system of claim 1, wherein the price for each item in the offer to buy is based on one or more selected from: a manufacturer's suggested retail price, a list price, a prevailing market price, and a prevailing online market price.

5. The system of claim 1, wherein the proposed purchase price comprises a partial payment for one or more of the plurality of items.

6. The system of claim 1, wherein the offer to buy comprises the time period, the time period configured by the buyer.

7. The system of claim 1, wherein the offer to buy comprises the time period, the time period configured by a software module.

8. The system of claim 1, wherein the funds comprise cryptocurrency.

9. The system of claim 1, wherein the funds comprise a coupon, a voucher, a gift card, currency, or a combination thereof.

10. The system of claim 1, wherein the verifying the availability of funds comprises receiving at least a portion of the funds.

11. Non-transitory computer-readable storage media encoded with a computer program including instructions executable by a processor to create an intermediary application for a reverse auction environment comprising:
a) a database, in a computer memory, of a plurality of sellers;
b) a software module configured to: receive an offer to buy from a buyer, the offer to buy directed to a plurality of items, each item having a price, the plurality of items comprising at least two non-identical items, the offer to buy having a total price;
receive a proposed purchase price for the plurality of items from the buyer, the proposed purchase price being equal to or less than the total price; and calculate a respective share of the proposed purchase price for each item;
c) a software module configured to verify availability of funds from the buyer in the amount of at least a portion of the proposed purchase price before or concurrent with receiving bids from one or more of the plurality of sellers;
d) a software module configured to receive bids from the plurality of sellers, the bids for sale of one or more of the plurality of items, each bid having a price for the one or more of the plurality of items in the bid;
e) a software module configured to select one or more bidding sellers upon the expiration of a time period, each selected seller bidding on one or more of the plurality of items at a price equal to or less than the share of the proposed purchase price for the items in the bid;
f) a dynamic item and price allocation module configured to allocate sale of each of the plurality of items to one or more of the selected sellers, wherein each item in the plurality of items is allocated at an allocated price, wherein the aggregate allocated price for the plurality of items is equal to or less than the proposed purchase price, the one or more sellers receiving the allocation based on one or more seller characteristics selected from the group consisting of: price, shipping speed, shipping provider, local delivery availability, local pickup availability, seller rating, seller ranking, number of previous sales, warranty, payment methods accepted, and condition of previously delivered items, the allocation immediately making the sale binding, wherein the allocation of sale of each of the plurality of items occurs after verifying availability of funds from the buyer or receiving bids from the plurality of sellers; and
g) a software module configured to distribute the verified funds to the one or more sellers, wherein the distribution of the verified funds occurs after verifying availability of funds from the buyer or receiving bids from the plurality of sellers.

12. The media of claim 11, wherein the items comprise goods, services, rights, or a combination thereof.

13. The media of claim 11, wherein the price for each item in the offer to buy is one or more of a manufacturer's suggested retail price and a list price.

14. The media of claim 11, wherein the price for each item in the offer to buy is based on one or more selected from: a manufacturer's suggested retail price, a list price, a prevailing market price, and a prevailing online market price.

15. The media of claim 11, wherein the proposed purchase price comprises a partial payment for one or more of the plurality of items.

16. The media of claim 11, wherein the offer to buy comprises the time period, the time period configured by the buyer.

17. The system of claim 11, wherein the offer to buy comprises the time period, the time period configured by a software module.

18. The media of claim 11, wherein the funds comprise cryptocurrency.

19. The media of claim 11, wherein the funds comprise a coupon, a voucher, a gift card, currency, or a combination thereof.

20. The media of claim 11, wherein the verifying the availability of funds comprises receiving at least a portion of the funds.

21. A system for computer-implemented auction technology in which guaranteed funds are dynamically allocated among a plurality of acquired items, comprising:
a) a digital processing device comprising an operating system configured to perform executable instructions and a memory;
b) a computer program including instructions executable by the digital processing device to create an intermediary application for a reverse auction environment comprising:
i. a database, in a computer memory, of a plurality of sellers;
ii. a software module configured to: receive an offer to buy from a buyer, the offer to buy directed to a plurality of items, each item having a price, the plurality of items comprising at least two non-identical items, the offer to buy having a total price; receive a proposed purchase price for the plurality of items from the buyer, the proposed purchase price being equal to or less than the total price; and calculate a respective share of the proposed purchase price for each item;
iii. a software module configured to verify availability of funds from the buyer in the amount of at least a portion of the proposed purchase price before or concurrent with receiving bids from one or more of the plurality of sellers;
iv. a software module configured to receive bids from the plurality of sellers, the bids for sale of one or more of the plurality of items, each bid having a price for the one or more of the plurality of items in the bid;
v. a software module configured to select one or more bidding sellers upon the expiration of a time period, each selected seller bidding on one or more of the plurality of items at a price equal to or less than the share of the proposed purchase price for the items in the bid;
vi. a dynamic item and price allocation module configured to allocate sale of each of the plurality of items to one or more of the selected sellers, wherein each item in the plurality of items is allocated at an allocated price, wherein the aggregate allocated price for the plurality of items is equal to or less than the proposed purchase price, the one or more sellers receiving the allocation based on one or more seller characteristics selected from the group consisting of: price, shipping speed, shipping provider, local delivery availability, local pickup availability, seller rating, seller ranking, number of previous sales, warranty, payment methods accepted, and condition of previously delivered items, the allocation immediately making the sale binding, wherein the allocation of sale of each of the plurality of items occurs after verifying availability of funds from the buyer or receiving bids from the plurality of sellers; and
vii. a software module configured to distribute the verified funds to the one or more sellers, wherein the distribution of the verified funds occurs after verifying availability of funds from the buyer or receiving bids from the plurality of sellers.

22. The system of claim 21, wherein the items comprise goods, services, rights, or a combination thereof.

23. The system of claim 21, wherein the price for each item in the offer to buy is one or more of a manufacturer's suggested retail price and a list price.

24. The system of claim 21, wherein the price for each item in the offer to buy is based on one or more selected from: a manufacturer's suggested retail price, a list price, a prevailing market price, and a prevailing online market price.

25. The system of claim 21, wherein the proposed purchase price comprises a partial payment for one or more of the plurality of items.

26. The system of claim 21, wherein the offer to buy comprises the time period, the time period configured by the buyer.

27. The system of claim 21, wherein the offer to buy comprises the time period, the time period configured by a software module.

28. The system of claim 21, wherein the funds comprise cryptocurrency.

29. The system of claim 21, wherein the funds comprise a coupon, a voucher, a gift card, currency, or a combination thereof.

30. The system of claim 21, wherein the verifying the availability of funds comprises receiving at least a portion of the funds.
